(19) United States
(12) Patent Application Publication
(10) Pub. No.: US 2026/0353449 A1
(43) Pub. Date: Nov. 5, 2026

(54) MEASUREMENT GAP USAGE BETWEEN TECHNOLOGIES HAVING A SHARED DUTY CYCLE

(71) Applicant: QUALCOMM Incorporated, San Diego, CA (US)

(72) Inventors: Varun WALIA, Hyderabad (IN); Sambit BEHURA, Hyderabad (IN); Praveen KONA, Hyderabad (IN); Amit Kumar SINGH, Hyderabad (IN); Rishav REJ, Pleasanton, CA (US); Nazmul ISLAM, Littleton, MA (US)

(21) Appl. No.: 19/195,590

(22) Filed: Apr. 30, 2025

(51) Int. Cl. H04W 74/0816; H04B 17/309; H04B 17/318; H04W 74/08

(52) U.S. Cl. CPC H04W 74/0816; H04B 17/328; H04B 17/346; H04W 74/0875

(57) ABSTRACT

A user equipment (UE) shares a radio frequency (RF) module between a first component for a first radio access technology (RAT) for wireless communication and a second component for a second technology that is different than the first RAT, wherein the RF module is shared based on a duty cycle having a first set of periodic time resources for the first RAT and a second set of periodic time resources for the second technology. The UE receives, from a network node, a configuration of one or more measurement gaps for the wireless communication based on the first RAT; and divert use of at least one of the one or more measurement gaps configured for the first RAT that occurs within one of: the first set of periodic time resources for the first RAT, or the second set of periodic time resources for the second technology.

### TECHNICAL FIELD

The present disclosure relates generally to communication systems, and more particularly, to wireless communication that includes measurement gaps.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and aspects of future technologies, such as 6G may be based on 5G NR and/or 4G LTE. There exists a need for further improvements in 5G NR and additional wireless communication technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus shares a radio frequency (RF) module between a first component for a first radio access technology (RAT) for wireless communication and a second component for a second technology that is different than the first RAT, wherein the RF module is shared based on a duty cycle having a first set of periodic time resources for the first RAT and a second set of periodic time resources for the second technology. The UE receives, from a network node, a configuration of one or more measurement gaps for the wireless communication based on the first RAT; and diverts use of at least one of the one or more measurement gaps configured for the first RAT that occurs within one of: the first set of periodic time resources for the first RAT, or the second set of periodic time resources for the second technology.

In an aspect of the disclosure, a method, a computer-readable medium, and an apparatus are provided for wireless communication at a network node. The apparatus receives, from a user equipment (UE), an uplink medium access control-control element (MAC-CE) indicating a request to divert use of one or more measurement gaps for a first radio access technology (RAT) for wireless communication that occurs within a set of periodic time resources for a second technology at the UE; and transmits a downlink MAC-CE that accepts, modifies, or rejects the request to divert the use of the one or more measurement gaps.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4A is a diagram illustrating example aspects of a UE having multiple components for different technologies that share an RF module based on a duty cycle, in accordance with various aspects of the present disclosure.

FIG. 4B illustrates an example duty cycle, e.g., for WWAN components and RED components, as an example of two technologies that share an RF module, in accordance with various aspects of the present disclosure.

FIG. 5A and FIG. 5B illustrate examples aspects of discontinuous reception, in accordance with various aspects of the present disclosure.

FIG. 5C illustrates an example of a duty cycle that includes opportunistic RFID operation in a WWAN duty cycle during a DRX OFF duration, in accordance with various aspects of the present disclosure.

FIG. 5D illustrates example aspects of TRM occupancy, in accordance with various aspects of the present disclosure.

FIG. 6 illustrates an example of a duty cycle that includes opportunistic RFID operation in a WWAN duty cycle during a DRX OFF duration, in accordance with various aspects of the present disclosure.

FIG. 7 is a flowchart and communication flow showing various aspects of measurement gap usage diversion, in accordance with various aspects of the present disclosure.

FIG. 8 illustrates example aspects of an UL MAC-CE, in accordance with various aspects of the present disclosure.

FIG. 9 illustrates example aspects of an UL MAC-CE, in accordance with various aspects of the present disclosure.

FIG. 10 illustrates example aspects of an UL MAC-CE, in accordance with various aspects of the present disclosure.

FIG. 11 illustrates example aspects of a DL MAC-CE, in accordance with various aspects of the present disclosure.

FIG. 12 illustrates an example of a duty cycle that includes measurement gap usage diversion, in accordance with various aspects of the present disclosure.

FIG. 13 illustrates an example of a duty cycle that includes measurement gap usage diversion, in accordance with various aspects of the present disclosure.

FIG. 14 illustrates an example flowchart that includes measurement gap usage diversion, in accordance with various aspects of the present disclosure.

FIG. 15 is a flowchart of a method of wireless communication, in accordance with various aspects of the present disclosure.

FIG. 16 is a flowchart of a method of wireless communication, in accordance with various aspects of the present disclosure.

FIG. 17 is a diagram illustrating an example of a hardware implementation for an example apparatus and/or UE, in accordance with various aspects of the present disclosure.

FIG. 18 is a diagram illustrating an example of a hardware implementation for an example network entity, in accordance with various aspects of the present disclosure.

### DETAILED DESCRIPTION

A UE may support both wireless communication via a radio access technology (RAT) (e.g., such as 5G NR, 6G, or a 3GPP technology) and may also support other wireless signaling technology (e.g., such as radio frequency identification (RFID) or another non-3GPP technology). As one, non-limiting example to illustrate the concept, a UE may support wireless communication based on a 5G NR RAT and may also support RED applications, such as an RFID-Tag-Scan Applications. The two technologies may access resources from a transceiver resource manager (TRM) in a shared manner based on a fixed duty cycle. In some aspects, the RAT for wireless communication may configure measurement gaps for the UE to measurement neighbor cells. During the measurement gaps, the UE may not transmit or receive communication. At times, a metric, such as a tag read rate, may fall below a threshold based on limits to the time for RFID operation in the duty cycle. Aspects presented herein provide for an RFID component (or other non-3PP technology) to coordinate with a wireless wide area network (WWAN) component of the UE to divert, or reuse, the measurement gaps that occur during the WWAN duty cycle to perform RFID activity. In some aspects, the UE may be in a mobile state or may be at cell edge. By skipping measurements in the measurement gaps that occur within the RFID cycle, may lead to a radio link failure (RLF) for the UE, which can not only affect the wireless communication, but may also reduce a tag read rate, as the WWAN activity may be prioritized over the RFID activity. In some aspects, when one or more conditions occur, the UE may perform WWAN measurements in measurement gaps that occur within an RFID duty cycle.

The measurement gap diversion aspects described herein can improve RFID operation and/or wireless communication operation by coordinating the reuse of measurement gap occasions that occur in a duty cycle for a different technology.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

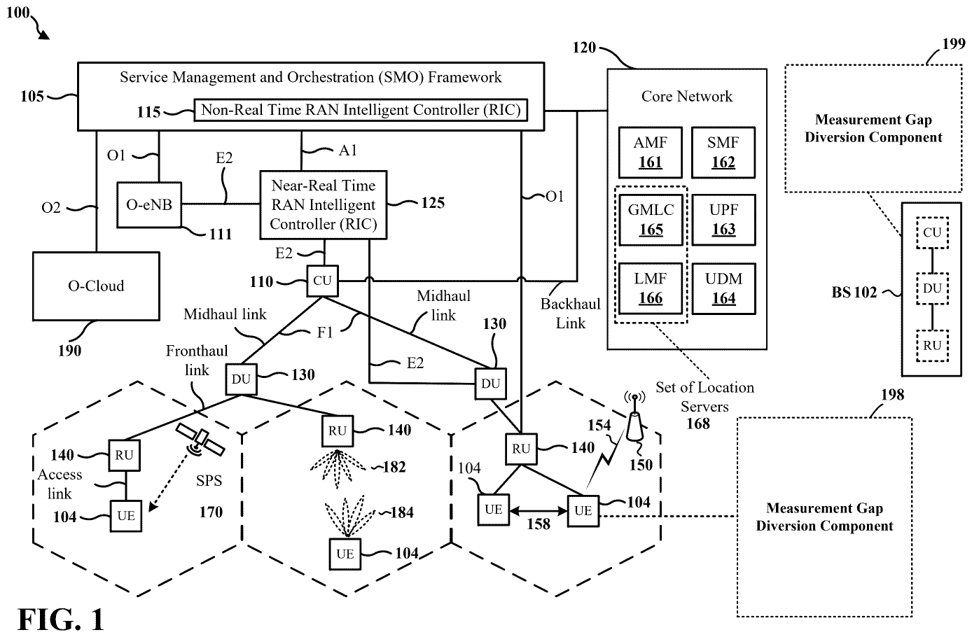

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a measurement gap diversion component 198 that may be configured to share a radio frequency (RF) module between a first radio access technology (RAT) for wireless communication and a second technology that is different than the first RAT, wherein the RF module is shared based on a duty cycle having a first set of periodic time resources for the first RAT and a second set of periodic time resources for the second technology; receive, from a network node, a configuration of one or more measurement gaps for the wireless communication based on the first RAT; and reuse at least one of the one or more measurement gaps configured for the first RAT that occurs within one of: the first set of periodic time resources for the first RAT, or the second set of periodic time resources for the second technology. In certain aspects, the base station 102 may have a measurement gap diversion component 199 that may be configured to receive, from a user equipment (UE), an uplink medium access control-control element (MAC-CE) indicating a request to reuse at least one of one or more measurement gaps for a first radio access technology (RAT) for wireless communication that occurs within a set of periodic time resources for a second technology at the UE; and transmits a downlink MAC-CE that accepts, modifies, or rejects the request

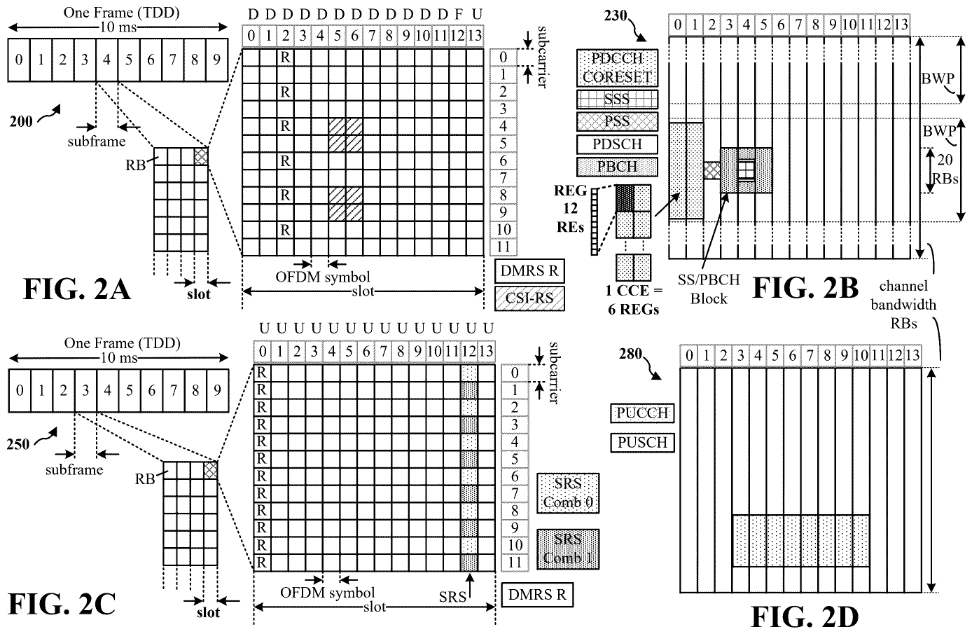

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology p=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

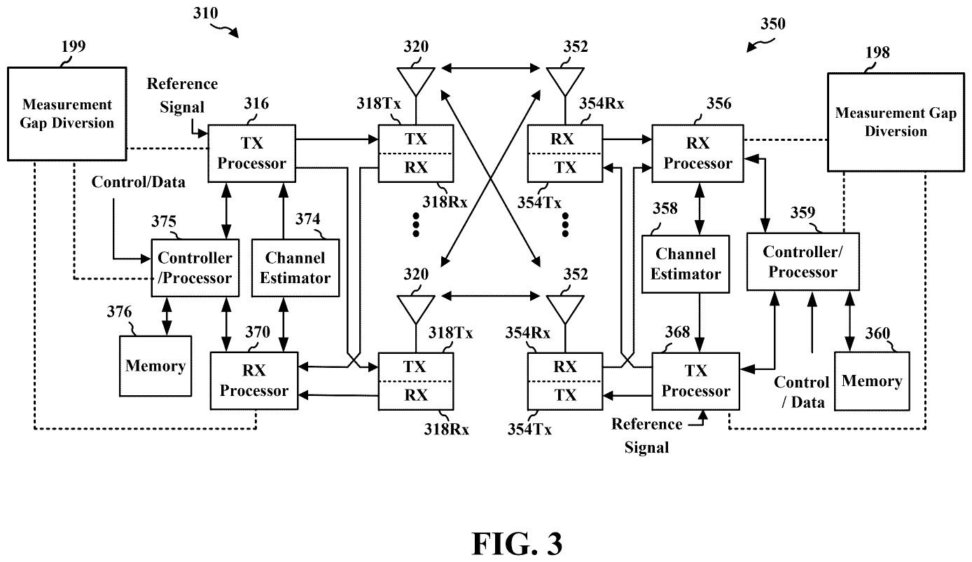

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the measurement gap diversion component 198 of FIG. 1.

At least one of the TX processor 316, the RX processor 370, and the controller/processor 375 may be configured to perform aspects in connection with the measurement gap diversion component 199 of FIG. 1.

In some aspects, a UE may transmit and receive wireless communication, such as with a network node, based on one or more measurement gaps to be observed in wireless communication resources. For example, in a measurement gap, a UE may temporarily stop transmitting and/or receiving with its serving cell in order to perform measurements on other cells or other frequencies. This enables the UE to assess the quality of neighboring cells or different frequencies without interrupting the UE's communication with its serving cell. In some aspects, multiple, concurrent measurement gaps may be used. In some aspects, the UE may receive a configuration of one or more measurement gaps from a network node (e.g., such as a base station or one or more components of a base station). The configuration of multiple measurement gaps enables the network node to activate/deactivate a subset of the previously configured measurement gaps. In some aspects, the activation/deactivation may be indicated on a per BWP basis.

As an example, a network node may send a configuration to a UE of a measurement gap configuration for the UE to perform inter-frequency neighbor cell measurements. At the measurement gap occasions, the UE tunes away from a serving cell frequency to the configured neighbor frequencies to measure signals from the neighbor cells. The base station avoids scheduling downlink or uplink data transmission or other signaling during the measurement gap occasions.

In some aspects, the base station can configure measurement gap configurations for different frequency ranges, e.g., an FR1 specific measurement gap configuration and/or an FR2 specific measurement gap configuration. In this example, the UE may receive two individual measurement gap configurations, e.g., one for FR1 and another for FR2. In other aspects, the UE may receive a single configuration that applies to multiple frequency ranges, e.g., such as a single UE specific overall measurement gap configuration. The single, UE specific configuration may be referred to as a “gapUE” configuration and applies to both FR1 and Fr2 frequencies. The frequency specific configuration may be referred to as “gapFR1” and “gapFR2,” in some aspects. If the UE specific configuration “gap UE” is configured for the UE, then individual “gapFR1” and “gapFR2” are not configured for the UE. In some aspects, the measurement gap configuration (e.g., which may be referred to as “MeasGapConfig” in some aspects) may be included as part of a measurement configuration (e.g., which may be referred to as a “MeasConfig,” in some aspects). A measurement configuration (e.g., MeasConfig) indicates measurements to be performed by the UE, e.g., including intra-frequency, inter-frequency and inter-RAT mobility. The measurement configuration may be received by the UE in RRC signaling and may indicate measurement identities for the UE to add and/or modify (e.g., measIDToAddModList) measurement objects for the UE to add or modify (measObjectToAddModList), report configurations for reports of measurements to the base station (e.g., reportConfigToAddModList), a measurement gap configuration (e.g., measGapConfig) that is used to set up and release measurement gaps for the UE. For example, the measurement gap configuration e.g., measGapConfig) may correspond to an IE that indicates the measurement gap configuration and controls setup and release of measurement gaps for the UE. The measGapConfig may indicate one or more measurement gap configurations to be added or modified (e.g., as gapToAddModList). Measurement gap configurations may be indicated with a measurement gap identifier (e.g., measGapId). A gap type may indicate the type of measurement gap, e.g., per UE or per a frequency range such as per FR1 or per FR2. In some aspects, one or more measurement gap configuration (e.g., GapConfig) that is configured (e.g., pre-configured) for the UE, may be indicated in RRC signaling such as in gapToAddModList, which may list up to 8 different measurement gap configurations that can operate concurrently in a time domain. Any of the gaps may be indicated as preconfigured gaps (e.g., based on preConfigInd), which remains inactive until the preconfigured measurement gap is activated, e.g., activated within a particular BWP. The configured measurement gap may likewise be deactivated. As an example, a BWP specific bitmask (e.g., preConfigGapStatus) may indicate an activated or deactivated status for one or more pre-configured measurement gaps for the BWP. As an example, a dedicated downlink BWP for the UE (e.g., BWP-DownlinkDedicated) may include a field preConfigGapStatus that indicates the activated or deactivated status for one or more preconfigured measurement gaps for the dedicated DL BWP. In the RRC configuration of each measurement gap configuration (e.g., GapConfig), a measurement gap identifier (e.g., measGapId) may indicate, as well as one or more of a gap type (e.g., gapType), a gap offset (e.g., gapOffset), a pre-configuration indication (e.g., preConfigInd) that indicates whether or not the measurement gap is a preconfigured measurement gap (e.g., that is used when activated and not used when deactivated), and/or a priority associated with the measurement gap (e.g., gapPriority), among other example parameters. In some aspects, a BWP configuration may include an indication associated with a preconfigured measurement gap.

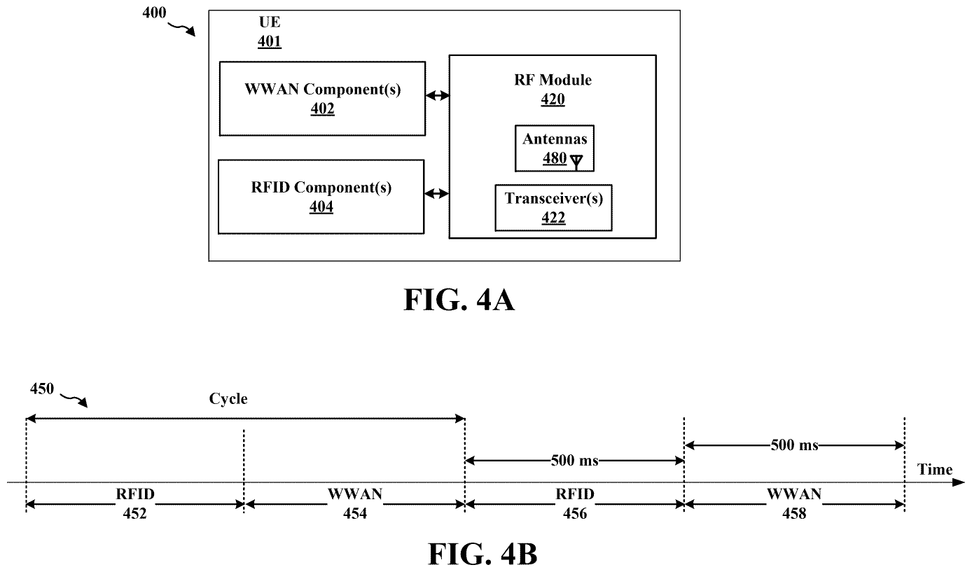

In some aspects, a UE may support both wireless communication via a radio access technology and may also support other wireless signaling technology, such as RFID. As one, non-limiting example to illustrate the concept, a UE may support wireless communication based on a 5G NR RAT and may also support RFID applications, such as an RFID-Tag-Scan Applications. FIG. 4A is a diagram 400 showing an example of a UE 401 that includes one or more WWAN components 402 for wireless communication based on a radio access technology (RAT). Examples of wireless communication RATs include 5G, 4G LTE, and 6G, for example. The UE 401 also includes components for another wireless signaling technology. In the example in FIG. 4A, the UE 401 includes RFID component(s) 404, as an example of another type of wireless signaling technology.

When an RFID application session is initiated at an application processor (AP) at the UE, the RFID stack (e.g., 404) may access resources from a transceiver resource manager (TRM) in a shared manner with the wireless communication RAT (e.g., 402). For example, the two technologies may share the TRM resources of an RF module 420 that includes, for example one or more transceivers 422 and one or more antennas 480, based on fixed duty cycle sharing. FIG. 4B is a time diagram 450 showing an example duty cycle for sharing transceiver resources, e.g., an RF module, between the WWAN component 402 of the UE 401 (e.g., time periods 454 and 458) and the RFID component 404 of the UE 401 (e.g., time periods 452 and 456). Among various possible examples of sharing transceiver resources, there may be a 50% duty cycle with 500 ms out of 1000 ms being assigned to the RFID Stack by the TRM (RFID duty cycle) and the remaining duration (e.g., the remaining 500 ms out of 1000 ms) being assigned for the wireless communication RAT (e.g., which may be referred to as a WWAN duty cycle or WWAN-5G duty cycle).

The RFID application, e.g., at the AP, may communicate with a middleware, which in turn communicates with the modem of the UE via Commands. For example, once the RFID application is launched at a user interface at the UE, the RFID application may starts running on the AP, which sends an activation request to the modem, which then brings up the lower layers of the RFID Stack.

For RFID and WWAN packet switched (PS) data scenarios, the TRM duty cycle sharing may be fixed (e.g., such as the example 50%, 500 ms out of 100 ms shown in FIG. 4B), in order to align with and accommodate other techs (5G, WLAN, etc.) and periodic modem activities that involve resource assignment from the TRM. In some aspects, the RFID stack may also additionally operate opportunistically within the WWAN duty cycle time periods during CDRX OFF durations, e.g., when the wireless communication (e.g., WWAN) stack is undergoing a sleep mode while in an RRC connected mode. For example, this may include concurrent RFID and WWAN activities on the modem.

When an instantaneous tag read rate is low, with a fixed duty cycle, the RFID component is not able to increase the RFID TRM usage duration (e.g., which may be referred to as a TRM occupancy) within the WWAN duty cycle (e.g., the portions of time for the WWAN) beyond what is available in the CDRX OFF durations.

The UE may be configured by a network node (such as a base station) for discontinuous reception (DRX). For example, when there is no data transmission in either direction (UL/DL), the UE may operate using the DRX mode in order to monitor for PDCCH transmissions discontinuously using a sleep and wake cycle (e.g., based on DRX OFF durations and DRX ON durations). When the UE is in an RRC connected state, the DRX mode may also be referred to as Connected Mode DRX (C-DRX). DRX conserves battery power at the UE. In a non-DRX mode, the UE monitors for PDCCH in each subframe to check whether there is downlink data available, which uses more battery power at the UE.

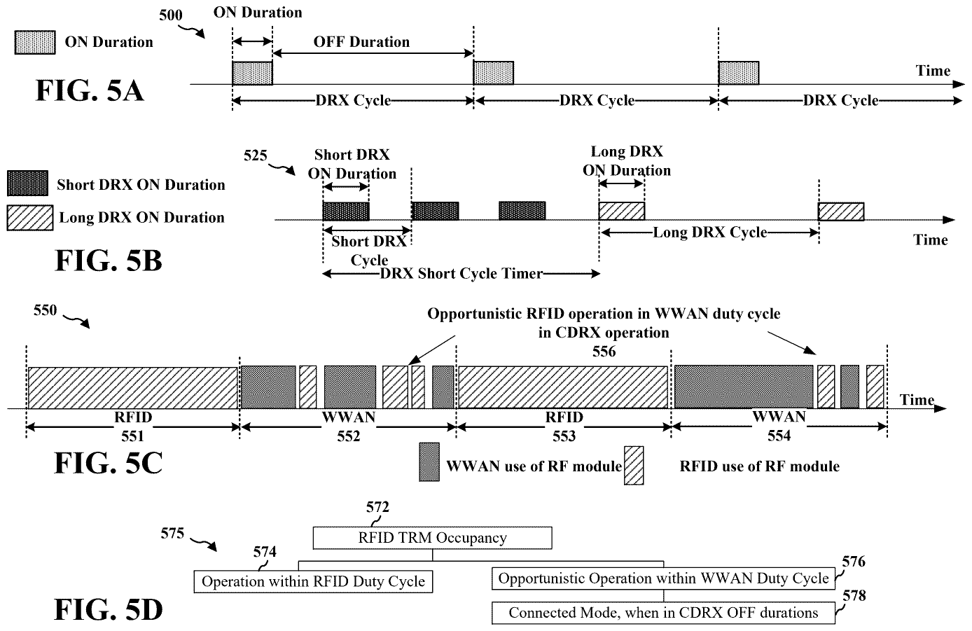

A DRX cycle may comprise a periodic repetition of ON durations in which the UE monitors for PDCCH from the base station and OFF durations during which the UE skips monitoring for PDCCH transmissions. FIG. 5A illustrates an example of a DRX cycle 500 including periodic ON durations during which the UE monitors for PDCCH and OFF durations during which the UE may skip monitoring for the PDCCH. During the OFF duration, the UE may enter a sleep mode or a low power mode in which the UE minimizes power consumption by shutting down a radio frequency (RF) function without detecting communication from the base station.

The UE may receive a DRX configuration from the network in RRC signaling that indicates one or more timers or values such as any of an ON duration Timer, a DRX inactivity timer, a DRX retransmission timer, a DRX UL retransmission timer, a long DRX cycle, a value of the DRX start offset, a DRX short cycle timer, and/or a short DRX cycle, among others.

The DRX ON duration timer may correspond to a number of consecutive PDCCH subframes or slots to be monitored or decoded when the UE wakes up from the OFF duration in the DRX Cycle. The DRX retransmission timer may correspond to a consecutive number of PDCCH subframes or slots for the UE to monitor when a retransmission is expected by the UE. The DRX inactivity timer may correspond to an amount of time before the UE may again enter the OFF duration following successfully decoding PDCCH. The amount of time may be in terms of a transmission time interval (TTI) duration. After a UE successfully receives downlink data, the DRX Inactivity Timer may start counting a number of subframes. If any uplink or downlink data transmissions occur while the DRX inactivity timer is running, the timer restarts. If the DRX inactivity timer expires without uplink or downlink activity, the UE may enter the DRX cycle to achieve power savings. The UE may start with a short DRX cycle.

The DRX short cycle may correspond to a first DRX cycle that the UE enters after successful expiration of DRX inactivity timer. FIG. 5B illustrates an example time diagram 525 showing an example DRX short cycle. The UE may operate using the short DRX cycle until a DRX short cycle timer expires. Once the DRX short cycle expires, the UE may enter a long DRX cycle, as shown in FIG. 5B.

RFID activity within CDRX OFF durations can be uncertain because the overall available OFF duration can vary for each individual DRX cycle. For example, the DRX OFF duration is based on the WWAN data traffic. If there is frequent data activity, then the UE might keep running the DRX inactivity timer (e.g., the “drx-InactivityTimer”) and stay in an ON duration or active duration throughout majority of a DRX cycle (e.g., which may be a long DRX cycle). The DRX OFF duration may be reduced within the WWAN duration based on the duty cycle, or there may be no DRX OFF duration during the WWAN duration of the duty cycle. In such examples, where the DRX OFF duration is reduced due to data traffic, the RFID tag read rate in the WWAN durations of the duty cycle is uncertain and may fall to a low tag read rate value.

FIG. 5C shows a time diagram 550 including a duty cycle for sharing an RF module between WWAN components and RFID components of a UE (e.g., such as the UE 401). As shown in FIG. 5C, the UE may be in a DRX OFF duration during the WWAN time period of the duty cycle (e.g., 552 and 554). The RFID application may opportunistically use the RF module during the DRX OFF durations, e.g., as the WWAN component is in a sleep mode and is not using the RF module. As shown at 552 and 554, the occurrence and length of the DRX OFF duration may vary.

FIG. 5D illustrates an example diagram 575 showing that the overall RFID TRM occupancy 572 (e.g., the amount of time that the RFID actually uses the RF module or transceiver) is based on (or is a function of) a combination of the RFID operation within the RFID duty cycle periods 574 (e.g., such as 551 and 553), the opportunistic operation of the RFID components within the WWAN duty cycle 576 (e.g., as shown at 556 within 552 and 554), and further based on the DRX OFF durations 578.

A RFID tag read performance may be based on an internal performance metric, which may include a threshold such as a minimum tag read rate (e.g., “Minimum-Tag-Read-Rate”) criteria that is assessed during the RFID application sessions. Apart from the time available based on the RFID duty cycle (e.g., 551 and 553), a higher tag read rate (# of tags read per second) can be achieved if the RFID Stack is allocated more operation duration corresponding to a higher TRM Occupancy within the WWAN periods of the duty cycle (e.g., 552 and 554).

Aspects presented herein provide ways for the RFID stack to initiate RFID activity within the WWAN periods of the duty cycle by using measurement gap occasions that fall within the WWAN duty cycle, to increase the overall RFID TRM occupancy and tag read rate. Measurement gaps occur at fixed points in the time domain with fixed durations, and data activity is not expected in those durations (e.g., the UE does not transmit or receive data during the measurement gaps). As the measurement gaps are at fixed points in time, the RFID activity within such measurement gaps can be estimated and predicted.

The use of measurement gaps within the WWAN time duration of the duty cycle for RFID activity may be referred to as diversion, measurement gap diversion, measurement gap usage diversion, and/or measurement gap reuse, among other examples. Some of the aspects presented herein can be performed autonomously by the UE and other aspects provide for coordination and/or assistance from a network for measurement gap usage diversion for an RFID application.

Although various examples are described herein using WWAN or 5G NR as examples of a wireless communication RAT, and RFID as the other technology, the aspects may be similarly applied for any combination of 3GPP RAT technology and non-3GPP technology that share an RF module of a UE based on a duty cycle in time.

The RFID and WWAN technologies share the modem based on the TRM duty cycle to access the modem's RF module based on certain priorities for the ongoing activities of each technology. For example, while the RFID Application is running, the WWAN priority may override that of the RFID application, e.g., when there is an incoming/ongoing voice call (VoLTE/VoNR).

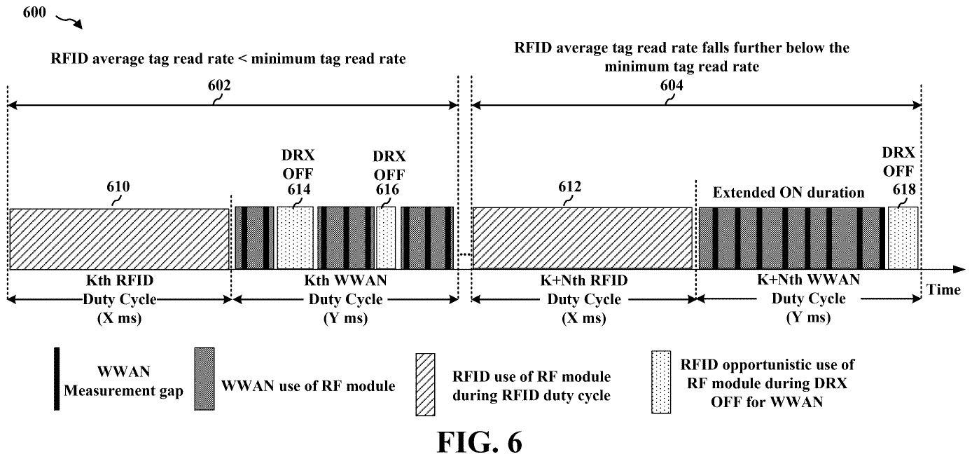

FIG. 6 illustrates an example 600 of RFID and WWAN concurrency for a UE (e.g., such as UE 401) that is in an RRC connected mode with a CDRX configuration and a measurement gap configuration. For example, an RFID stack at the UE is activated and the UE operates based on a fixed TRM duty cycle sharing for RFID and WWAN communication. The RFID application and the WWAN components of the UE share an RF module based on a TRM duty cycle. FIG. 6 shows that the RFID portion of the duty cycle may include X ms, and the WWAN portion of the duty cycle may include Y ms. X may be equal to Y or may be different. Similar to FIG. 5C, FIG. 6 shows that the RFID application may opportunistically divert use of the RF module during the DRX OFF durations within the WWAN duty cycle. FIG. 6 shows that across the K RFID+WWAN duty cycle (e.g., for the time period 602), the average tag read rate is below a threshold minimum tag read rate. During a following time period (based on the K+Nth duty cycle, e.g., for the time period 604), the UE is in an extended DRX ON duration based on data traffic and the DRX OFF duration is reduced in comparison to the time period 602. In this example, K and N are positive integer numbers. This leaves less time for the RFID activity during the DRX OFF duration, and the average tag read rate falls further below the minimum tag read rate for the time period 604.

FIG. 6 also shows that measurement gap occasions occur within the WWAN duty cycle. As described herein, the measurement gap occasions are provided for the UE to perform measurements (e.g., for inter-frequency, intra-frequency, and/or inter-RAT mobility) and the UE does not transmit or receive data during the measurement gap occasions.

Throughout the RFID regions in the time domain (e.g., including the RFID duty cycles 610 and 612 in combination with the opportunistic RFID operation in the CDRX OFF durations 614, 616, and 618), the RFID stack attempts to meet the minimum tag read rate criteria (e.g., which may be averaged out across the entire RFID application session), to ensure that the RFID performance is optimal and competitive.

When the tag read rate stays below this lower limit (e.g., below the minimum tag read rate criteria) across a threshold number (e.g., an integer number K) RFID and WWAN duty cycles, the RFID application is not able to improve the RFID performance in the next K duty cycles, e.g., based on the constraints of the fixed TRM duty cycle sharing with the WWAN components of the UE and an unchanged DRX configuration. If the WWAN data activity leads to the UE reducing DRX OFF durations (e.g., drx-InactivityTimer running for substantial portions of the DRX cycle) during the WWAN portion of the duty cycle, then the RFID tag read rate further falls. Data traffic is unpredictable, and a reliance on CDRX OFF durations for RFID activity might not provide optimal tag read rates at times.

When a network node, such as a base station configures measurement gaps for a UE, both the base station and the UE honor the configured measurement gap by suspending downlink and uplink transmissions in the configured measurement gap occasions. As presented herein in a RFID and WWAN concurrency scenarios (or other 3GPP RAT and non-3GPP technology concurrency scenario based on a shared TRM duty cycle), when RFID activity is high priority (e.g., meets a priority condition), within the WWAN duty cycle, one or more measurement gap occasions may be diverted to use for RFID operation to achieve a higher TRM occupancy for the RFID and a possibly higher tag read rate. In some aspects, the use may be referred to as diverted use or reuse, e.g., measurement gap usage diversion for non-3GPP technology.

When the average tag read rate falls below the minimum tag read rate criteria across a particular number of RFID duty cycles, the RFID stack can send an indication (e.g., such as an “RFID-Meas-Gap Usage Diversion Indication”) to the WWAN Layer 1 (e.g., NR physical (PHY) Layer). In some aspects, the indication may indicate a preferred number of upcoming measurement gap occasions to be utilized for RFID operation. In the example in FIG. 6, based on a determination that the average tag read rate was below the minimum tag read rate for the time period 602, the RFID component may request to use, for RFID activity, one or more measurement gap occasions during the K+Nth WWAN duty cycle, for example.

The WWAN L1 can then suspend the inter-frequency measurements scheduled on the indicated upcoming gap occasions, and the TRM can allocate RFID activity in the indicated measurement gap occasions.

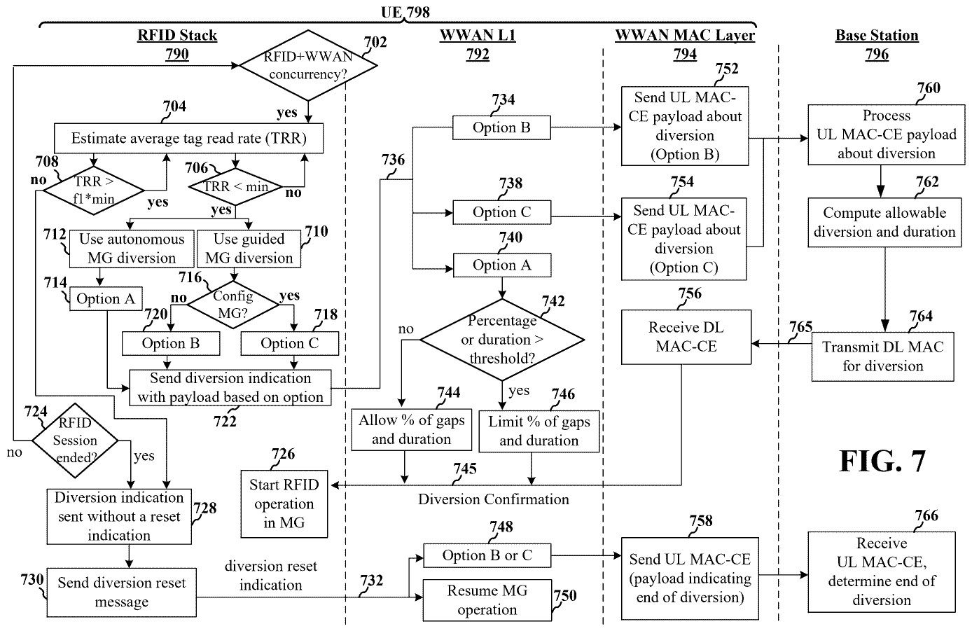

There may be various different options for the diversion of use of measurement gaps by the RFID component. For example, in a first option, which may be referred to as option A, the UE may autonomously determine to divert use of one or more measurement gaps to the RFID application. In other options, the UE may coordinate, or communicate with a network node, such as a base station, about the diversion usage of WWAN measurement gaps for RFID activity. As an example, in a second option, which may be referred to as option B and a third option, which may be referred to as option C, the UE may communicate or coordinate with the network about the measurement gap usage diversion. For example, option B (at 720) and option C (at 718) may be referred to as guided measurement gap diversion, e.g., as shown at 710. FIG. 7 illustrates an example flowchart that includes aspects of different potential options, including the examples described as options A-C. FIG. 7 shows actions that are performed by and communication flow between the RFID stack 790 (e.g., as an example of another technology that may share an RF module with a wireless communication technology or radio access technology (RAT), a RAT L1 792, a RAT MAC layer 794 (e.g., layer 2), and a network node (e.g., base station 796). The RFID stack 790, RAT L1 792, and the RAT MAC layer 794 are part of the UE 798 (e.g., which may correspond to the UE 401 in FIG. 4A, for example).

### Option A Example:

When the RFID application is initiated at an application processor of the UE 798, the RFID stack (e.g., RFID components) and WWAN stack (e.g., WWAN components for a connected mode with a RAT (e.g., such as 5G or 6G)) may start to operate concurrently with fixed TRM duty cycle sharing of the RF components, e.g., such as described in connection with any of FIGS. 4A-6. FIG. 7 shows the consideration of whether the RFID components and WWAN components are operating concurrently based on a shared duty cycle, at 702. If so, at 704, the lower layers (e.g., L1+L2) of the RFID stack 790 monitor the tag read rate, e.g., average tag read rate across a moving evaluation window of “K” consecutive RFID+WWAN duty cycles.

As shown at 706, the RFID stack 790 determines whether the average tag read rate (TRR) in an evaluation window falls below a threshold (e.g., minimum tag read rate (e.g., “min”)). If not, the RFID stack 790 continues to monitor the TRR. If the average tag read rate in any evaluation window does fall below the threshold (e.g., TRR<min), the RFID stack 790 decides that a higher tag read rate can be achieved by more RFID activity within the measurement gap occasions in the WWAN duty cycles The threshold (e.g., minimum tag read rate) may be a defined metric that is defined in the lower layers of the RFID stack. The RFID may analyze the delta between minimum tag read rate and the achieved average tag read rate, and internally compute a metric (using the algorithm presented herein) that is proportional to a percentage number of upcoming and concurrently running measurement gap occasions (e.g., per measurement gap configuration ID/across all measurement gap configuration IDs) in the WWAN duty cycle, to be utilized for RFID Activity, to improve the tag read rate.

As shown at 722, the RFID stack 790 then sends an internal RFID measurement gap usage diversion indication message (e.g., 736) to the L1 of the WWAN stack (e.g., 792). This indication message 736 may be used in connection with each of options A, B, and C, for example.

In some aspects, the payload of the indication message 736 may vary for the different options. As an example, for options A (e.g., 714) and option B (e.g., 720), the indication message 736 may include a computed percentage of the number of upcoming measurement gaps and concurrently running, measurement gap occasions (across all measurement gap configuration IDs), to be utilized for RFID activity. The indication message 736 may also include or otherwise indicate a requested duration for the measurement gap usage diversion.

In some aspects, for option C (e.g., 718), when there are previously configured measurement gaps, and if there are some inactive or deactivated measurement gaps (of the configured measurement gaps) in the active BWP, the indication message 736 may include, or otherwise indicate, one or more deactivated measurement gaps to be activated, and the computed percentage number of upcoming measurement gap occasions (per measurement gap configuration ID), to be utilized for RFID Activity. The indication message may also include, or otherwise indicate, the requested duration for the measurement gap usage diversion.

Upon receiving this indication message 736 from the RFID stack 790, the WWAN components (e.g., the L1 792) may take various actions based on the different example options.

For option A (e.g., 740), (e.g., a UE autonomous diversion example), the L1 may 792 suspend inter-frequency neighbor cell searches and/or measurement scheduling for the indicated percentage of gap occasions per measurement gap configuration (e.g., as indicated in the indication message 736), and the NR stack may stop TRM usage of the RF module during those measurement gap occasions, as shown at 744. In some aspects, there may be one or more thresholds associated with diversion of measurement gap occasions (e.g., an internal higher limit “Max_gap_percentage_diversion” that corresponds to a maximum percentage number of measurement gaps that can be allowed by the UE to be diverted for RFID usage and/or a “max-Duration-of-Gap-Usage-Diversion” that corresponds to the maximum duration in time for which the gap usage diversion will be allowed, once diversion is started). As shown at 742, the L1 may determine whether the percentage and/or duration requested in the indication message 736 exceeds either threshold. For example, the L1 792 may determine whether the requested gap percentage for diversion is greater than the maximum gap percentage for diversion and/or whether the requested duration for the measurement gap diversion is greater than a maximum gap percentage diversion duration. If the percentage and duration requested in the indication message 736 is not greater than the threshold(s), at 744, the L1 792 may allow the requested percentage of measurement gaps to be used for RFID activity for the requested duration. If one or more of the thresholds is exceeded, as determined at 742, the L1 792 may limit the percentage of measurement gaps and/or the duration of diversion, at 746, so that the measurement gap diversion stays within the maximum thresholds. As shown at 745, the L1 may provide a configuration message about the requested measurement gap diversion, informing the RFID stack 790 that the requested diversion is accepted and/or modifying the percentage and/or duration for the requested diversion.

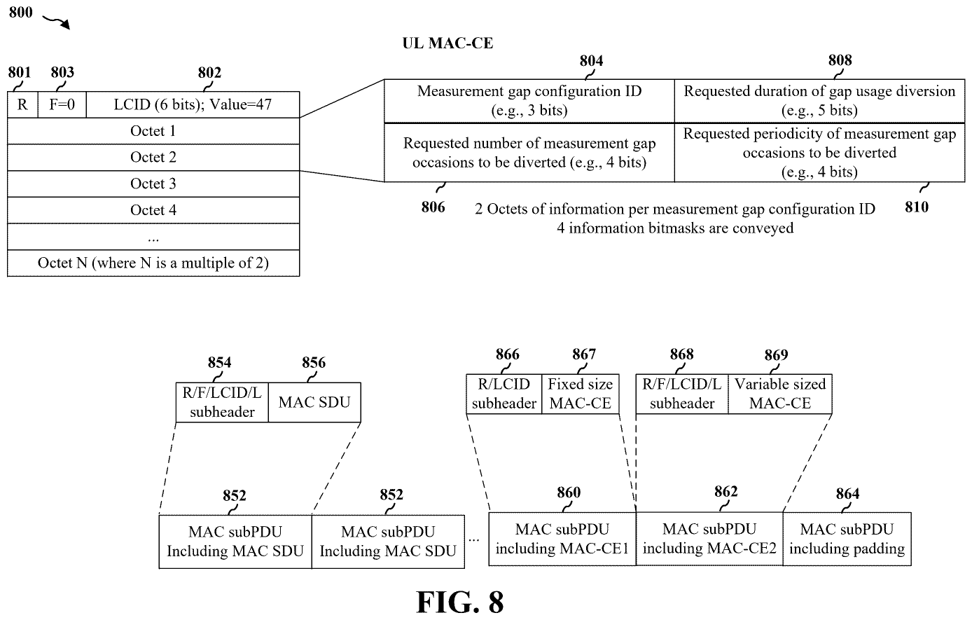

In some aspects, the diversion may be further coordinated with the network node (e.g., such as a base station 796 or one or more components of a base station). Such examples may be referred to as network guided options. Options B and C, for example, may include communication with the network (e.g., base station 796) about the measurement gap diversion for use by the RFID stack 790. For example, the 11 792 sends an indication to the MAC layer 794 (e.g., WWAN MAC layer) for the MAC layer 794 to transmit an UL MAC-CE (e.g., 752 or 754) about the measurement gap usage diversion (e.g., in an example in which the WWAN layers are for NR, the MAC-CE may be referred to as an NR Meas-Gap Usage Diversion for Non-3GPP Request). FIG. 8 illustrates example aspects of an UL MAC-CE structure that may be used by the UE to indicate the request. The UL MAC-CE may include a reserved/unused LCID and may include a payload that conveys, to the base station 796, a percentage number of measurement gap occasions (per Meas-Gap-ID) to be utilized for the non-3GPP technology (e.g., RFID in this example). The payload of the MAC-CE may also convey the requested duration for measurement gap usage diversion.

The MAC Layer transmits the UL-MAC-CE (e.g., 752 or 754) and monitors for reception of a DL MAC-CE 765 from the base station (e.g., 796) with a response to the UL MAC-CE. In an example in which the WWAN is NR, the DL MAC-CE may be called an NR Meas-Gap Usage Diversion for Non-3GPP Response MAC-CE, for example. The DL MAC-CE 765 may include a reserved/unused LCID and a payload of this response message that either confirms the acceptance of the requested measurement gap usage diversion, modifies an “allowed” measurement usage diversion (e.g., as determined at 762), or rejects the requested measurement gap usage diversion for the UE. The payload of the DL MAC-CE 765 may also indicate a maximum duration in time until which the gap usage diversion is allowed, once started (e.g., “max-Duration-of-Gap-Usage-Diversion”). For example, the base station 796 may process the received UL-MAC-CE at 760 and transmit a response in a DL MAC-CE at 764.

As shown at 756, the UE's MAC Layer 794 receives the DL MAC-CE 765 and sends the received information to the L1 794. The L1 may then send a confirmation message (e.g., 745) to the RFID stack 790. For example, the L1 792 may then send an “RFID-Meas-Gap Usage Diversion Confirmation” to the RFID stack 790 confirming, or otherwise indicating, the percentage number of the upcoming measurement gap occasions (per Meas-Gap Config ID) and/or the pattern of the measurement gap occasions that can be utilized for RFID operation (e.g., either based on the internal higher allowed limit, as determined at 742, or received in the DL MAC-CE 765). The confirmation message (e.g., 745) may also indicate the overall duration during the measurement gap usage diversion for RFID is allowed (either the internal limit from 746, or received in the DL MAC-CE at 765). The L1 792 suspends the inter-frequency neighbor search/measurement scheduling for the indicated number of measurement gap occasions for the indicated duration, and the WWAN stack stop stops TRM usage on those measurement occasions.

As shown at 726, the RED stack may then perform the RFID operation in the measurement gaps of the WWAN duty cycle. For example, the RFID stack 790 may perform RFID operation, e.g., as per the provided pattern, within the measurement gap occasions of the upcoming WWAN duty cycles, e.g., until the indicated duration of measurement gap usage diversion.

In some aspects, if the average tag read rate has improved by a factor (e.g., which may be referred to as “f1” or “improved_read_rate_factor”), within an evaluation window, as shown at 708, then the RFID stack 790 may send an message 732 to the L1 (e.g., a “reset message” or “RFID-Meas-Gap Usage Diversion Reset Indication” message) to inform the L1 792 that the measurement gap usage diversion will cease. The improved_read_rate_factor may be a defined metric that is defined in the lower layers) of the RFID stack 790.

When the RFID application is terminated at the AP, e.g., as determined at 724, the RFID stack 790 may send the message 732, e.g., the “RFID-Meas-Gap Usage Diversion Reset Indication” message, to the L1 792.

Upon receiving the message 732, the L1 792 may terminate the measurement gap usage diversion and resume measurement gap operation for inter-frequency neighbor cell searches and measurements, as shown at 750. In Option A (e.g., the UE autonomous example), the UE may resume the measurement gap operation at the WWAN components without sending additional indications to the network.

In the network guided examples of option B or option C, the L1 may send an indication (e.g., 748) to the MAC layer 794, to transmit an UL MAC-CE (e.g., “NR Meas-Gap Usage Diversion for Non-3GPP Request” MAC-CE) with a payload to indicate to the base station 796 that the measurement gap usage diversion has ended at the UE 798. The L1 792 terminates the measurement gap usage diversion and resumes measurement gap operation for inter-frequency neighbor cell searches and measurements, as shown at 750.

The MAC layer 794 transmits the UL MAC-CE 758. The base station 796 receives this UL-MAC-CE and interprets, at 766, that the measurement gap usage diversion has ended. In some aspects, the base station 796 may receive the UL MAC-CE without sending a response.

In some aspects, in which a UE autonomously determines to perform measurement gap usage diversion (e.g., such as option A), the measurement gap usage diversion for RFID operation happens without informing the gNB regarding the same.

When across a moving window of “K” RFID+WWAN duty cycles (e.g., where K is a positive integer number), if the average tag read rate falls below the threshold minimum, the RFID stack 790 may compute one or more metrics (e.g., such as a percentage of gaps for the diversion and/or a duration for the diversion. The Gap_percentage_diversion, for example, may correspond to a percentage of upcoming and concurrently running measurement gap occasions (e.g., across all of the measurement gap configuration IDS) in the WWAN duty cycle, to be utilized for RFID activity, to attempt to improve the tag-read-rate towards the threshold minimum tag read rate. The Duration_of_Gap_Usage_Diversion, for example, may correspond to a duration in milliseconds during which the measurement gap usage diversion is to be performed to attempt to improve the tag-read-rate. In some aspects, the metrics may be computed based on a look up table. The indication message 736 may then include the two computed metrics regarding the measurement gap usage diversion requested for RFID.

As discussed in connection with 742, there may be some internal upper limits against which the requested measurement gap usage diversion metrics in the indication message 736 can be compared and capped. For example, a “Max_gap_percentage_diversion” may indicate the maximum percentage of measurement gaps that can be allowed by the UE to be diverted for RFID usage. As another example, a “Max-Duration-of-Gap-Usage-Diversion” may indicate the maximum duration for the gap usage diversion, once started. These internal upper limits can help to ensure that measurement gap usage is not diverted beyond a certain threshold, as to minimize the impact on WWAN mobility procedures. For example, at 742, the L1 792 may compute, or otherwise determine, a pattern of measurement gap occasions (per Meas Gap Config ID) as the measurement gaps to be diverted for RFID usage. The confirmation message 745 may indicate the determined pattern to the RED stack 790, e.g., as an “L1 Computed Meas-Gap Diversion Pattern and Duration,” e.g., for each of the WWAN duty cycles falling in the time duration MIN(Duration_of_Gap_Usage_Diversion, Max-Duration-of-Gap-Usage-Diversion).

To match the percentage of measurement gaps to be diverted given by MIN(Gap_percentage_diversion, Max_gap_percentage_diversion), the “L1 Computed Meas-Gap Diversion Pattern and Duration” may indicate (e.g., at 745), for Meas Gap Configuration: a measurement gap configuration ID (e.g., Meas Gap Config ID), a number of measurement gap occasions that are to be diverted towards RFID usage, the periodicity of repetition of measurement gap usage diversion, and a time duration for which measurement gap usage diversion can be performed (e.g., MIN(Duration_of_Gap_Usage_Diversion,Max-Duration-of-Gap-Usage-Diversion).

The L1 792 sends the internal “RFID-Meas-Gap Usage Diversion Confirmation” message (e.g., 745) to the RFID stack 790 with the “L1 Computed Meas-Gap Diversion Pattern and Duration.” The RFID stack 790 then pushes RFID operation as per the provided pattern within the measurement gap occasions of the upcoming WWAN duty cycles, at 726, and until the allowed duration of measurement gap usage diversion.

As shown at RFID stack may send a reset message (e.g., 732, an “RFID-Meas-Gap Usage Diversion Reset Indication” message) to the L1 792 based on the occurrence of one or more conditions. For example, if the average tag read rate has improved by a factor (e.g., “improved_read_rate_factor”) within an evaluation window of “K” RFID+WWAN duty cycles (e.g., if TDD>f1*min, as shown at 708) or if the RFID application/session is terminated at the AP, as shown at 724, the RFID stack 790 may send the diversion reset indication (e.g., 732) to the WWAN components (e.g., L1 792). In some aspects, the RFID stack 790 may consider, at 728, whether a diversion indication (e.g., 736) without a reset indication having been sent. If so, the RFID stack may then send the message, at 730.

Upon receiving the reset message, at 732, the L1 792 terminates the measurement gap usage diversion and resumes measurement gap operation for inter-frequency neighbor cell searches and measurements, as shown at 750. Table 2 shows aspects of an example look up table that may be used to compute a percentage of measurement gaps to be diverted and/or a duration for the measurement gap usage diversion. The table is merely an example to illustrate the concept of use of a look up table, and in practice, a look up table may include different values.

TABLE 2

| Delta between Minimum- | | |
|---|---|---|
| Tag-Read-Rate and | | |
| current Average Tag- | Gap percentage for | Duration of Gap Usage |
| Read-rate | diversion | Diversion |
| ≤10% | 50% | [5*(X + Y)] ms |
| >10% and ≤30% | 80% | [10*(X + Y)] ms |
| >30% | 100% | [15*(X + Y)] ms |

Table 2 shows examples of values ranges for a difference between a threshold (e.g., “Minimum-Tag-Read-Rate”) and a current, or measured, tag read rate (e.g., “Average Tag-Read-rate”) can be expressed as a percentage based on:

[(Minimum TRR−Average TRR)/Minimum TRR]*100

Table 2 shows that the ranges of the delta may be associated with a percentage for diversion of measurement gaps. The gap percentage for diversion may correspond to the percentage of measurement gaps, e.g., across all measurement gap configuration IDs, in the WWAN duty cycle that are to be used for RFID activity. The duration of gap usage diversion may be based on the duration of an RFID TRM duty cycle (e.g., “X”), and the duration of a WWAN TRM Duty Cycle (e.g., “Y”), such as shown in the example in FIG. 6. For example, if the delta is less than 10%, the RFID stack 790 may request diversion of 50% of the measurement gaps for a duration of 5 complete duty cycles (e.g., a combination of RFID and WWAN duty cycles). If the delta is 20%, the RFID stack 790 may request diversion of 80% of the measurement gaps for a duration of 10 complete duty cycles (e.g., a combination of RFID and WWAN duty cycles). If the delta is 35%, the RFID stack 790 may request diversion of 100% of the measurement gaps for a duration of 15 complete duty cycles (e.g., a combination of RFID and WWAN duty cycles).

For the network guided options, e.g., options B or C that include communication or coordination with the network, the measurement gap diversion for RFID operation, at 726, may happen after requesting confirmation from the base station 796.

In some aspects, the use of option B (e.g., 720, 734, and 752) or option C (e.g., 718, 738, and 754) may be based on whether the UE 798 has previously configured measurement gaps, e.g., as determined at 716. This sub-solution is to be implemented

If the UE has not received measurement gap configurations, e.g., for measurement gap IDs, the UE may use option B, at 720. When across a moving window of “K” RFID+WWAN duty cycles, and the average tag read rate falls below the minimum tag read rate, the RFID stack 790 may compute, or otherwise determine, the gap percentage for diversion (e.g., the percentage of upcoming and concurrently running measurement gap occasions in the WWAN duty cycle to be used for RFID activity to attempt to improve the tag read rate), computes the following metrics: (same as Sub-Solution A) and/or the duration of the gap usage diversion (e.g., duration in ms for the measurement gap usage diversion to be performed to attempt to improve the tag read rate). The determination may be based on a look up table, e.g., such as table 2.

The RFID stack 790 then sends the indication message 722 with the determined metrics. The L1 computes a pattern of measurement gap occasions (per measurement gap Config ID) that can be diverted for RFID Usage and a duration (e.g., “L1 Computed Meas-Gap Diversion Pattern and Duration” and “L1 Computed Meas-Gap Diversion Pattern and Duration”), e.g., similar to with 742, 744, and/or 746. For example, the L1 792 may indicate, for each measurement gap configuration to be used for diversion, a measurement gap configuration ID, a number of measurement gap occasions for that measurement gap configuration ID that are to be diverted towards RFID Usage, the periodicity of repetition of Meas-Gap Usage Diversion, and a time duration for which the measurement gap diversion is to be performed (e.g., “Duration_of_Gap_Usage_Diversion”). In contrast to option A, rather than sending the determined diversion information to the RFID stack, the L1 792 may send the “L1 Computed Meas-Gap Diversion Pattern and Duration” to the MAC Layer 794, at 752. The MAC layer 794 encapsulates the data into an UL MAC Sub-PDU with a variable-Size-MAC-CE over the Logical Channel DCCH, e.g., with a corresponding LCID that indicates measurement gap usage diversion and sends the UL MAC-CE to the base station 796 at 752. In some aspects, the LCID may be a Reserved LCID 47 that indicates “NR Meas-Gap Usage Diversion for Non-3GPP Request.” The base station 796 receives the UL MAC-CE and processes the payload at 760. As an example, upon receiving the MAC-CE from the UE 798 with an LCID 47 (as an example of an LCID to indicate measurement gap usage diversion), the base station 796 reviews the requested measurement gap usage diversion per measurement gap Config ID.

Based on the UE's cell mobility history and/or other data points, the base station 796 may either accept the UE's request, or the base station 796 may modify the measurement gap usage diversion to an allowed measurement gap usage diversion per measurement gap Config ID. The base station's MAC layer then encapsulates the allowed measurement gap usage diversion per Meas Gap Config ID into a DL MAC Sub-PDU with a variable-Size-MAC-CE and transmits the MAC-CE 765. For example, the base station 796 may transmit the MAC-CE over a logical channel DCCH with an LCID (e.g., such as “Reserved LCID 46” to indicate “NR Meas-Gap Usage Diversion for Non-3GPP Response”).

The UE receives the DL MAC-CE 765 (e.g., with LCID 46), and the MAC layer 794 interprets the payload and passes the information to L1 792. The L1 792 then compiles the data into a message for the RFID stack that includes the diversion metrics allowed by the base station (e.g., which may be referred to as “gNB allowed Meas-Gap Diversion Pattern and Duration” in a 5G NR example). The “base station allowed Meas-Gap Diversion Pattern and Duration” may include, for example, one or more measurement gap configuration identified by a measurement gap configuration ID, a number of measurement gap occasions for that measurement gap configuration ID, that are to be diverted towards RFID Usage, and the periodicity of repetition of measurement gap usage diversion, e.g., as confirmed by or modified by the base station 796. The message may further include a time duration for which the measurement gap usage diversion is to be performed, e.g., “Duration_of_Gap_Usage_Diversion,” as confirmed by or modified by the base station 796. The L1 792 then sends an internal message (e.g., such as an “RFID-Meas-Gap Usage Diversion Confirmation” message) to the RFID stack 790, the message including the allowed diversion metrics, as confirmed, or modified, by the base station 796.

The RFID stack 790 then pushes RFID operation, e.g., based the provided pattern within the measurement gap occasions of the upcoming WWAN duty cycles, and until the indicated duration of measurement gap usage diversion, as indicated by the base station.

For option B, if the RFID stack sends the reset indication message, e.g., 732, the UE 798 (e.g., via the MAC layer 794) informs the base station 796 that the measurement gap diversion has ended, by sending an UL MAC-CE at 758. For example, the MAC layer 794 may re-initiate an UL MAC Sub-PDU, but this time with a Fixed-Size-MAC-CE over the Logical Channel DCCH with “Reserved LCID 47” to indicate the measurement gap usage diversion (e.g., a “NR Meas-Gap Usage Diversion for Non-3GPP Request”) to the base station 796. The fixed size MAC-CE payload can be set to a defined pattern, such as all zeros, to indicate to the base station that the measurement gap usage diversion has ended at the UE. The base station 796 receives the U1 MAC-CE, at 766 and determines that the measurement gap usage diversion has ended at the UE. The ML1 terminates the measurement gap usage diversion and resumes measurement gap operation, e.g., at 750.

Option C is another example of a network guided, or network coordinated option in which the measurement gap usage diversion for RFID operation happens after requesting confirmation from the base station. Option C may be implemented, e.g., when the UE has received a configuration (e.g., from the base station 796) of one or more measurement gaps having measurement gap configuration IDs. As an example, the child-IE (e.g., which may be referred to as “preConfigInd” or “preConfigInd-r17”) may be configured as “True” for some/all of the measurement gap configuration IDs that are configured under the parent-IE (e.g., gapToAddModList which may be referred to as “gapToAddModList-r17”), and in the active DL BWP (e.g., under the parent IE “BWP-DownlinkDedicated”). The child-IE which may be referred to as “preConfigGapStatus-r17” may be a bitmask that indicates that only a subset of all the configured measurement gaps are active in a given BWP. For example, there may be some configured measurement gap configurations (identified by Meas Gap Config IDs) that are inactive within that BWP. When the average tag read rate falls below the minimum, as determined at 706, and if there are measurement gap configurations configured for the UE, as determined at 716, the UE may apply option C, at 718. The RFID state may determine the previously configured measurement gaps to activate (e.g., a list of currently inactive configured Gap Config IDs to be activated for RFID usage). The metric might not be computed or may be redundant if the BWP specific IE (e.g., “preConfigGapStatus-r17”) indicates that all of the configured measurement gaps are already active in that given BWP. In that case, option B may be used, at 720. The RFID state may determine a gap percentage for diversion, e.g., a percentage of and concurrently running measurement gap occasions (across all Meas Gap config IDs, including the currently active measurement gap configuration IDs and the new requested configured gap configuration IDs to be activated for RFID Usage) in the WWAN duty cycle for use for RFID activity. The RFID stack 790 may determine a duration of gap usage diversion, e.g., as a duration in milliseconds for the measurement gap usage diversion to be performed. The determined metrics can be determined based on a look up table, such as Table 2 or Table 3.

The RFID stack 790 then sends an internal indication message 736 to the L1 792, which contains the computed metrics regarding measurement gap usage diversion requested for RFID. The ML1 computes a pattern of measurement gap occasions (per measurement gap Config ID) as per which the measurement gaps can be diverted for RFID Usage (e.g., which may be called “L1 Computed Meas-Gap Diversion Pattern and Duration”). The metrics may include the currently active measurement gap configuration IDs and the new requested configured measurement gap configuration IDs that are requested to be activated for RFID Usage. For example, the “L1 Computed Meas-Gap Diversion Pattern and Duration” may include, for each measurement gap configuration, a measurement gap configuration ID, a number of measurement gap occasions for that measurement gap configuration UE that are to be diverted towards RFID usage, and the periodicity of repetition of measurement gap usage diversion, and a time duration for which measurement gap usage diversion is to be performed (e.g., a “Duration_of_Gap_Usage_Diversion”). The L1 792 then sends the “L1 Computed Meas-Gap Diversion Pattern and Duration” to the MAC Layer 794 at 738. The MAC layer 794 the encapsulates the data into an UL MAC-CE, at 754, e.g., such as an UL MAC Sub-PDU with a variable size MAC-CE over the logical channel DCCH with “Reserved LCID 47” to indicate “NR Meas-Gap Usage Diversion for Non-3GPP Request” to the base station 796.

On receiving this UL MAC-CE, (e.g., with LCID 47), the base station 796 reviews the UE's requested measurement gap usage diversion per measurement gap configuration ID, at 760 and 762. For example, the base station may identify the inactive, configured measurement gap configuration IDs that the UE is requesting to be activated for non-3GPP technology usage (e.g., such as RFID). Based on the UE's cell mobility history and/or other data points, as considered at 762, the base station may either accept the UE's request or may modify the allowed measurement gap usage diversion per measurement gap configuration ID. At 764, the MAC layer of the base station 796 then encapsulates the allowed measurement gap usage diversion per measurement gap Config ID into a DL MAC Sub-PDU with a variable-Size-MAC-CE over the Logical Channel DCCH (e.g., with “Reserved LCID 46” to indicate “NR Meas-Gap Usage Diversion for Non-3GPP Response”), similar to option B.

At the UE 798, on receiving the DL MAC-CE at 756 (e.g., with LCID 46), the MAC layer 794 interprets the payload and passes the information to L1 792, e.g., similar to option B. For example, the ML1 may compile the data into a message for the RFID stack that includes the diversion metrics allowed by the base station (e.g., which may be referred to as “gNB allowed Meas-Gap Diversion Pattern and Duration” in a 5G NR example). The “base station allowed Meas-Gap Diversion Pattern and Duration” may include, for example, one or more measurement gap configurations identified by a measurement gap configuration ID, a number of measurement gap occasions for that measurement gap configuration ID, that are to be diverted towards RFID usage, and the periodicity of repetition of measurement gap usage diversion, e.g., as confirmed by or modified by the base station 796. The message may further include a time duration for which the measurement gap usage diversion is to be performed, e.g., “Duration_of_Gap_Usage_Diversion,” as confirmed by or modified by the base station 796. The L1 792 then sends an internal message (e.g., such as an “RFID-Meas-Gap Usage Diversion Confirmation” message) to the RFID stack 790, the message including the allowed diversion metrics, as confirmed, or modified, by the base station 796.

The RFID stack 790 then pushes RFID operation, e.g., based the provided pattern within the measurement gap occasions of the upcoming WWAN duty cycles, and until the indicated duration of measurement gap usage diversion, as indicated by the base station.

For option C, similar to option B, if the RFID stack sends the reset indication message, e.g., 732, the UE 798 (e.g., via the MAC layer 794) informs the base station 796 that the measurement gap diversion has ended, by sending an UL MAC-CE at 758. For example, the MAC layer 794 may re-initiate an UL MAC Sub-PDU, but this time with a Fixed-Size-MAC-CE over the Logical Channel DCCH with “Reserved LCID 47” to indicate the measurement gap usage diversion (e.g., a “NR Meas-Gap Usage Diversion for Non-3GPP Request”) to the base station 796. The fixed size MAC-CE payload can be set to a defined pattern, such as all zeros, to indicate to the base station that the measurement gap usage diversion has ended at the UE. The base station 796 receives the U1 MAC-CE, at 766 and determines that the measurement gap usage diversion has ended at the UE. The ML1 terminates the measurement gap usage diversion and resumes measurement gap operation, e.g., at 750.

TABLE 3

| Delta between | | | |
|---|---|---|---|
| Minimum-Tag- | | | |
| Read-Rate and | Gap | Duration of Gap | |
| current Average | percentage | Usage | |
| Tag-Read-rate | for diversion | Diversion | Configured gaps to activate |
| ≤10% | 50% | [5*(X + Y)] ms | Add the first inactive, |
| | | | configured Gap Config ID to |
| | | | the list |
| >10% and | 80% | [10*(X + Y)] ms | If >2 inactive configured Gap |
| ≤30% | | | Config IDs, then add the first |
| | | | 2 inactive configured Gap |
| | | | Config IDs to the list. |
| | | | Else, add all the Inactive |
| | | | configured Gap Config IDs to |
| | | | the list. |
| >30% | 100% | [15*(X + Y)] ms | If >4 inactive configured Gap |
| | | | Config IDs, then add the first |
| | | | 4 Inactive configured Gap |
| | | | Config IDs to the list. |
| | | | Else, add all the Inactive |
| | | | configured Gap Config IDs to |
| | | | the list. |

FIG. 8 illustrates an example of an UL MAC-CE payload structure 800 that may be used in connection with the example measurement gap usage diversion described in FIG. 7. For example, the UL MAC-CE may correspond to the UL MAC-CE 752 or 754 for option B or option C. FIG. 8 shows a structure of an UL-MAC-Sub-PDU with variable size MAC-CE that the UE can send to indicate to the base station 796 that UE 798 is requesting to start measurement gap usage diversion (e.g., for “NR Meas-Gap Usage Diversion for Non-3GPP Request” in an example in which the WWAN is NR) (e.g., such as at 752 or 754). The MAC-CE in FIG. 8 may include an LCID 802 having a value that is a unique identifier for the UL-MAC-Sub-PDU that carries a measurement gap usage diversion request from the UE 798 (e.g., such as at 752 or 754). As one, non-limiting example, the LCID=47 is reserved for UL-SCH and can act as a unique identifier for the UL-MAC-Sub-PDU that carries a measurement gap usage diversion request from the UE 798. FIG. 8 shows that the header may include an R field 801, an F field 803, and/or an LCID 802. The octets may include, for each measurement configuration that is indicated, any combination of a measurement gap configuration ID 804, a requested number of measurement gap occasions to be diverted 806, a requested duration of gap usage diversion 808, and/or a requested periodicity of the measurement gap occasions to be diverted 810. As the number of measurement gap configurations to be indicated may vary, the size of the MAC-CE is variable. FIG. 8 illustrates an example in which four bitmasks (e.g., 804, 806, 808, and 810) may be conveyed in two octets of information, as an example. FIG. 8 also shows aspects of an UL MAC PDU, that may include one or more MAC subPDUs 852, each including a header 854 (e.g., that may include fields such as an R field, an F field, an LCID field, and an L field) and a MAC SDU 856, and one or more MAC subPDUs including MAC-CEs. FIG. 8 shows an example of a MAC subPDU including MAC-CE1 860 (e.g., as an example of a fixed size MAC-CE), and a MAC subPDU including MAC-CE2 862 (e.g., as an example of a variable size MAC-CE). FIG. 8 further shows that the transmission may include a MAC subPDU 864 that includes padding. The fixed size MAC-CE 867 may be included with a subheader 866 that includes one or more fields (e.g., such as an R field and/or an LCID field) that identifies the type of MAC-CE. The size of the MAC-CE is fixed. The variable size MAC-CE 869 may be included with a subheader 868 that includes one or more fields (e.g., such as an R field and/or an LCID field) that identifies the type of MAC-CE. The size of the MAC-CE varies based on the amount of information carrier in the MAC-CE. For example, the size may vary based on the amount of measurement gap configurations identified in a request for measurement gap usage diversion.

FIG. 8 illustrates an example of an UL MAC-CE payload structure 800 that may be used in connection with the example measurement gap usage diversion described in FIG. 7. For example, the UL MAC-CE may correspond to the UL MAC-CE 752 or 754 for option B or option C. FIG. 8 shows a structure of an UL-MAC-Sub-PDU with variable size MAC-CE that the UE can send to indicate to the base station 796 that UE 798 is requesting to start measurement gap usage diversion (e.g., for “NR Meas-Gap Usage Diversion for Non-3GPP Request” in an example in which the WWAN is NR) (e.g., such as at 752 or 754). The MAC-CE in FIG. 8 may include an LCID 802 having a value that is a unique identifier for the UL-MAC-Sub-PDU that carries a measurement gap usage diversion request from the UE 798 (e.g., such as at 752 or 754). As one, non-limiting example, the LCID=47 is reserved for UL-SCH and can act as a unique identifier for the UL-MAC-Sub-PDU that carries a measurement gap usage diversion request from the UE 798. FIG. 8 shows that the header may include an R field 801, an F field 803, and/or an LCID 802. The octets may include, for each measurement configuration that is indicated, any combination of a measurement gap configuration ID 804, a requested number of measurement gap occasions to be diverted 806, a requested duration of gap usage diversion 808, and/or a requested periodicity of the measurement gap occasions to be diverted 810. As the number of measurement gap configurations to be indicated may vary, the size of the MAC-CE is variable. FIG. 8 illustrates an example in which four bitmasks (e.g., 804, 806, 808, and 810) may be conveyed in two octets of information, as an example. FIG. 8 also shows aspects of an UL MAC PDU, that may include one or more MAC subPDUs 852, each including a header 854 (e.g., that may include fields such as an R field, an F field, an LCID field, and an L field) and a MAC SDU 856, and one or more MAC subPDUs including MAC-CEs. FIG. 8 shows an example of a MAC subPDU including MAC-CE1 860 (e.g., as an example of a fixed size MAC-CE), and a MAC subPDU including MAC-CE2 862 (e.g., as an example of a variable size MAC-CE). FIG. 8 further shows that the transmission may include a MAC subPDU 864 that includes padding. The fixed size MAC-CE 867 may be included with a subheader 866 that includes one or more fields (e.g., such as an R field and/or an LCID field) that identifies the type of MAC-CE. The size of the MAC-CE is fixed. The variable size MAC-CE 869 may be included with a subheader 868 that includes one or more fields (e.g., such as an R field and/or an LCID field) that identifies the type of MAC-CE. The size of the MAC-CE varies based on the amount of information carrier in the MAC-CE. For example, the size may vary based on the amount of measurement gap configurations identified in a request for measurement gap usage diversion.

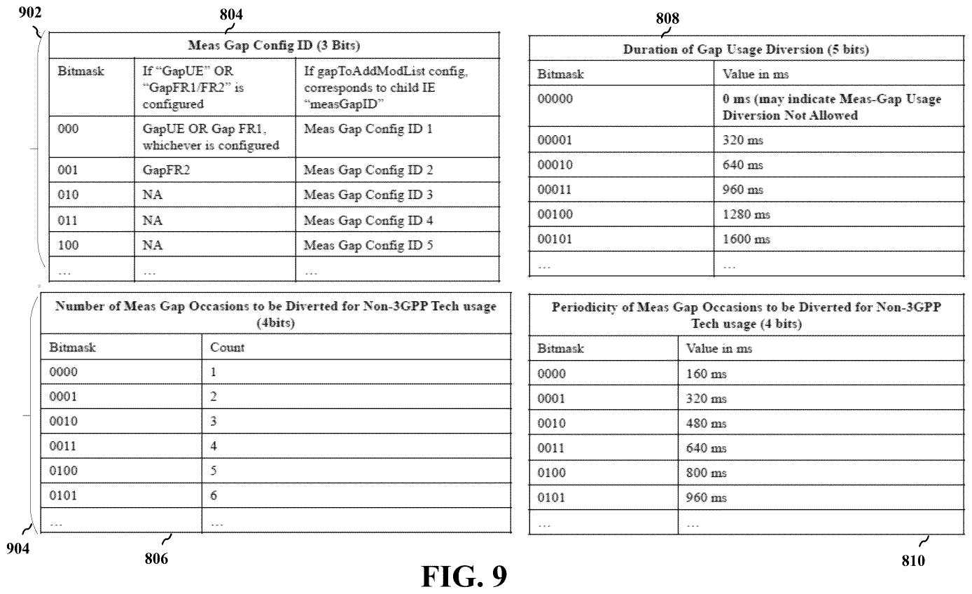

FIG. 9 illustrates an example of bitmasks that may be carried in a first octet 902 and a second octet 904 to provide the information for 804, 806, 808, and 810. Additional values are shown in Tables 4, 5, 6, and 7.

TABLE 4
Meas Gap Config ID (3 Bits)

| | If “GapUE” OR | If gapToAddModList |
|---|---|---|
| | “GapFR1/FR2” is | config, corresponds to |
| Bitmask | configured | child IE “measGapID” |
| 000 | GapUE OR Gap FR1, | Meas Gap Config ID 1 |
| | whichever is configured | |
| 001 | GapFR2 | Meas Gap Config ID 2 |
| 010 | NA | Meas Gap Config ID 3 |
| 011 | NA | Meas Gap Config ID 4 |
| 100 | NA | Meas Gap Config ID 5 |
| 101 | NA | Meas Gap Config ID 6 |
| 110 | NA | Meas Gap Config ID 7 |
| 111 | NA | Meas Gap Config ID 8 |

TABLE 5
Duration of Gap Usage Diversion (5 bits)

| Bitmask | Value in ms |
|---|---|
| 00000 | 0 ms - Indicates Meas-Gap Usage |
| | Diversion Not Allowed |
| 00001 | 320 ms |
| 00010 | 640 ms |
| 00011 | 960 ms |
| 00100 | 1280 ms |
| 00101 | 1600 ms |
| 00110 | 1920 ms |
| . . . | . . . |
| 1110 | 9600 ms |
| 1111 | 9920 ms |

TABLE 6
Number of Measurement Gap Occasions to be Diverted (4 bits)

| Bitmask | Count |
|---|---|
| 0000 | 1 |
| 0001 | 2 |
| 0010 | 3 |
| 0011 | 4 |
| 0100 | 5 |
| 0101 | 6 |
| 0110 | 7 |
| . . . | . . . |
| 1110 | 15 |
| 1111 | 16 |

TABLE 7
Periodicity of Measurement Gap Occasions to be Diverted (4 bits)

| Bitmask | Value in ms |
|---|---|
| 0000 | 160 ms |
| 0001 | 320 ms |
| 0010 | 480 ms |
| 0011 | 640 ms |
| 0100 | 800 ms |
| 0101 | 960 ms |
| 0110 | 1120 ms |
| . . . | . . . |
| 1110 | 2400 ms |
| 1111 | 2560 ms |

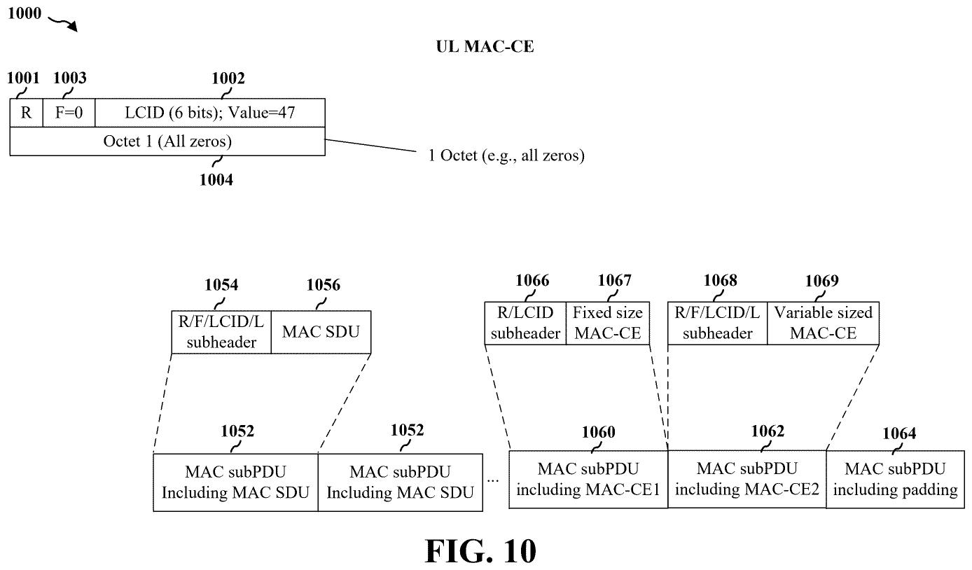

FIG. 10 illustrates an example of an UL MAC-CE 1000 payload structure for a fixed size that the UE 798 may send (e.g., for a NR Meas-Gap Usage Diversion for Non-3GPP Request), to indicate to the base station 796 that the measurement gap usage diversion has ended at the UE 798 (e.g., which may correspond to the UL MAC-CE 758). For example, for option B or option C, the MAC-CE may be sent to the base station 796 when the diversion is stopped, e.g., by MAC layer 794 when the L1 792 receives the reset message 732 from the RFID stack 790. In this example, the payload may have a value that is associated with the measurement gap usage diversion ending notification. As an example, in one octet, the payload may be all zeros. The payload (e.g., 1 octet of all zeros for the fixed Size MAC-CE) may be kept different than the values described in connection with FIG. 9 for the variable size MAC-CE that has at least 2 octets of information per measurement configuration ID, under the same LCID (e.g., LCID 47). The LCID indicates that the MAC-CE is about measurement gap usage diversion. The unique value in the single octet indicates the end of the diversion to the base station 796. The MAC-CE may include a header with an R field 1001, an F field 1003, and an LCID 1002, and a single octet 1004. The MAC-CE has a fixed size, as the number of octets does not vary from the single octet.

FIG. 10 also shows aspects of an UL MAC PDU, that may include one or more MAC subPDUs 1052, each including a header 1054 (e.g., that may include fields such as an R field, an F field, an LCID field, and an L field) and a MAC SDU 1056, and one or more MAC subPDUs including MAC-CEs. FIG. 10 shows an example of a MAC subPDU including MAC-CE1 1060 (e.g., as an example of a fixed size MAC-CE), and a MAC subPDU including MAC-CE2 1062 (e.g., as an example of a variable size MAC-CE). FIG. 10 further shows that the transmission may include a MAC subPDU 1064 that includes padding. The fixed size MAC-CE 1067 may be included with a subheader 1066 that includes one or more fields (e.g., such as an R field and/or an LCID field) that identifies the type of MAC-CE. The size of the MAC-CE is fixed. The variable size MAC-CE 1069 may be included with a subheader 1068 that includes one or more fields (e.g., such as an R field and/or an LCID field) that identifies the type of MAC-CE. As shown at 1004, the UL MAC-CE may convey the end of the measurement gap usage diversion using a single octet, and therefore may correspond to the fixed size MAC-CE 1067.

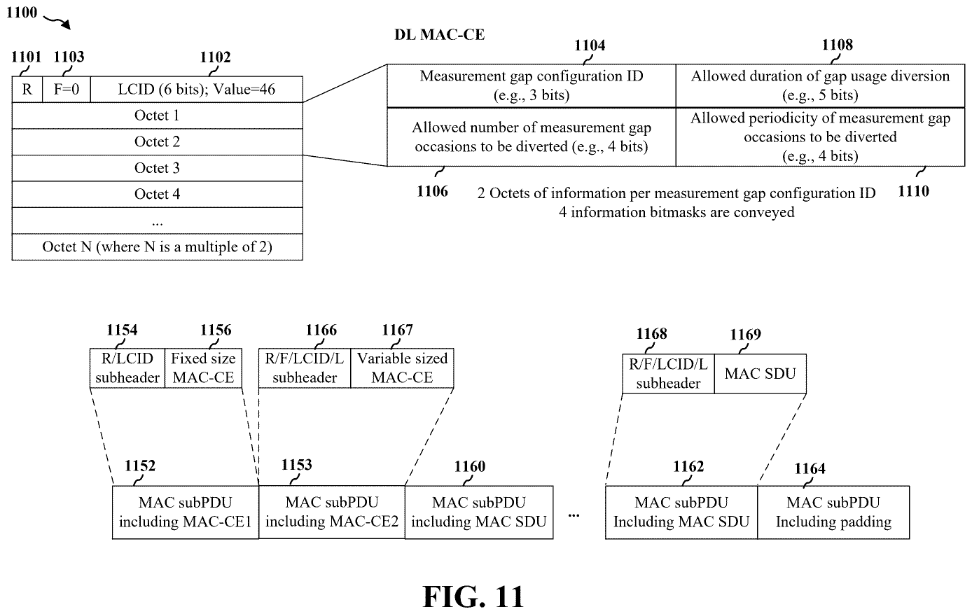

FIG. 11 illustrates an example of a DL MAC-CE payload structure 1100 (e.g., a variable size MAC-CE) that the base station 796 may use to send a measurement gap usage diversion response (e.g., which may correspond to 764, 765) to indicate the base station's approved/allowed parameters for measurement gap usage diversion at the UE 798, e.g., in connection with the example measurement gap usage diversion described in FIG. 7.

The MAC-CE may include an LCID 1102 having a value that is a unique identifier for the DL MAC-Sub-PDU that carries a measurement gap usage diversion response from the base station 796 (e.g., such as at 764, 765). As one, non-limiting example, the LCID=46 is reserved for DL-SCH and can act as a unique identifier for the DL MAC-Sub-PDU that carries a measurement gap usage diversion response. FIG. 11 shows that the header may include an R field 1101, an F field 1103, and/or an LCID 1102. In an example in which the WWAN is for 5G NR, the response may be referred to as an “NR Meas-Gap Usage Diversion for Non-3GPP Response.” The octets may include, for each measurement configuration that is indicated, any combination of a measurement gap configuration ID 1104, an allowed (or confirmed) number of measurement gap occasions for diversion 1106, an allowed (or confirmed) duration of gap usage diversion 1108, and/or an allowed (or confirmed) periodicity of the measurement gap occasions to be diverted 1110. As the number of measurement gap configurations to be indicated may vary, the size of the MAC-CE is variable. FIG. 11 illustrates an example in which four bitmasks (e.g., 1104, 1106, 1108, and 1110) may be conveyed in two octets of information, as an example. The bitmask information may include the information shown in FIG. 9 and/or described in connection with any of Tables 4-7, for example. For a given measurement gap configuration ID, if the base station 796 does not want to allow the measurement gap usage diversion (e.g., for RFID or another non-3GPP technology), the base station 796 can set the duration bitmask (e.g., 1108) for the measurement gap configuration ID to a particular value such as all zeros, e.g., “00000”. This may be used to indicate to the UE 798 that the UE is not to use that given measurement gap configuration ID for RFID operation (e.g., or other non-3GPP operation).

FIG. 11 also shows an example of a downlink MAC PDU that may include the variable sized MAC-CE (e.g.,). FIG. 11 also shows aspects of an DL MAC PDU, that may include one or more MAC subPDUs (e.g., 1152, 1153, 1160, 1162, 1164), each including a header (e.g., 1154, 1166, 1168) (e.g., that may include fields such as an R field, an F field, an LCID field, and an L field). The MAC subPDU 1162 is shown as including a MAC SDU 1169, and the MAC subPDU 1164 is shown as including padding. FIG. 11 shows an example of a MAC subPDU including MAC-CE1 1156 (e.g., as an example of a fixed size MAC-CE), and a MAC subPDU including MAC-CE2 1167 (e.g., as an example of a variable size MAC-CE). The variable size MAC-CE 1167 may be included with a subheader 1166 that includes one or more fields (e.g., such as an R field, F field, L field, and/or an LCID field) that identifies the type of MAC-CE. The size of the MAC-CE varies based on the amount of information carrier in the MAC-CE. For example, the size may vary based on the amount of measurement gap configurations identified in a response for measurement gap usage diversion.

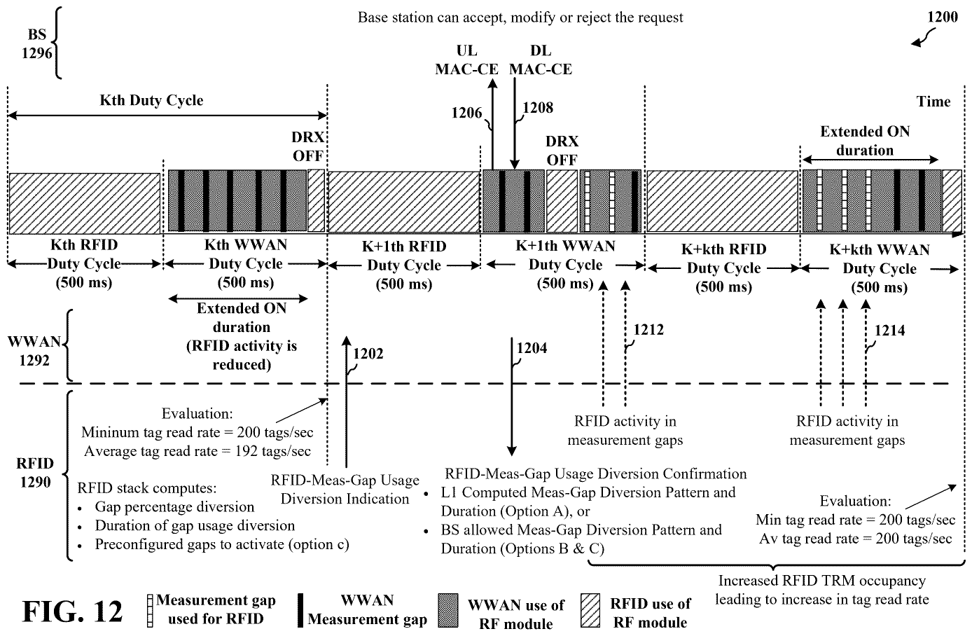

FIG. 12 illustrates an example timeline 1200 showing an example of measurement gap usage diversion for RFID activity during a WWAN duty cycle, e.g., such as described in connection with FIGS. 7-11. FIG. 12 illustrates aspects that may be performed by an RFID component 1290 and a WWAN component 1292 of a UE (e.g., which may correspond to the RFID stack 790 and WWAN components (e.g., 792 and 794) of the UE 798 in FIG. 7) that share an RF module of the UE, such as illustrated for the UE 401 in FIG. 4A, and concurrently operate based on a TRM duty cycle, e.g., such as described in connection with FIGS. 4B, 5C, and/or 6. FIG. 12 also illustrates aspects that may involve a base station 1296, e.g., which may correspond to the base station 796 in FIG. 7. During the Kth duty cycle, e.g., which includes the Kth RFID duty cycle and the Kth WWAN duty cycle, the RFID component 1290 may opportunistically use the RF module during a DRX off duration. As shown in FIG. 12, at the end of the Kth duty cycle, the average tag read rate for the RED component 1290 is 192 tags/sec, which is below the minimum tag read rate of 200 tags/sec. As shown at 1202, the RFID component 1290 may send a measurement gap usage diversion indication to the WWAN component 1292 of the UE to indicate that the RFID component 1290 is requesting to use some of the measurement gap occasions that occur during one or more WWAN duty cycles to perform RFID activity. The WWAN component 1292 may respond with a confirmation 1204 (e.g., which may allow, modify and/or reject the request, as described in connection with 745 in FIG. 7). In some aspects, the UE may autonomously determine to use some of the measurement gaps for RFID activity, e.g., such as described in connection with Option A in FIG. 7. In some aspects, the UE may coordinate with a network node, such as a base station 1296, for the measurement gap usage diversion (e.g., as described in connection with either option B or C in FIG. 7). As an example, the WWAN component 1292 of the UE may transmit an UL MAC-CE 1206 to the base station 1296 with information about, or a request for, measurement gap usage diversion. The UL MAC-CE 1206 may correspond to the UL MAC-CE described at 752 or 754, for example. The base station 1296 may respond with a DL MAC-CE 1208 that confirms, modifies, or rejects the requested measurement gap diversion.

The DL MAC-CE 1208 may correspond to 764 or 765, for example. In some aspects, the confirmation at 1204 may be based on the information received from the base station in the DL MAC-CE 1208. For example, in some aspects, the confirmation may be based on or indicate an L1 computed measurement gap diversion pattern and duration (e.g., such as in option A in FIG. 7), or may include a base station allowed measurement gap diversion pattern and duration (e.g., such as in option B or option C in FIG. 7).

As shown at 1212 and 1214, based on the confirmation at 1204, the RFID component 1290 may perform RFID activity in the measurement gap occasions that fall within the WWAN duty cycle, e.g., at least based on the pattern, percentage, measurement gap configuration ID, repetition, and/or duration indicated by the confirmation 1204. FIG. 12 illustrates that the added opportunities for RFID activity may help to increase the tag read rate to meet the minimum tag read rate.

In the example in FIG. 12, there may be a 50% TRM duty sharing between the RFID component 1290 and the WWAN component 1292 (e.g., each duty cycle spanning 500 ms out of every 1000 ms, e.g., for 1000 ms, X=500 ms, allocated to the RFID component 1290, and Y=500 ms allocated to the WWAN component 1292). C-DRX may be configured for the WWAN component and performed within the WWAN duty cycle. The RFID operation is limited to C-DRX OFF duration in the WWAN duty cycle and varies based on the time-variable data traffic for the WWAN component 1292.

In FIG. 12, a defined performance metric, e.g., “Minimum-Tag-Read-rate” for the RFID stack may be 200 tags/sec. After an evaluation window spanning “K” RFID duty cycles, the “Average-Tag-Read-Rate”=192 tags/see, which is below the minimum (e.g., such as determined at 706 in FIG. 7), and causing the RFID component 1290 to request measurement gap usage diversion.

The aspects presented herein provide for interactions between the RFID stack and the ML1 and MAC Layers of a WWAN protocol stack in a way to coordinate assistance of improvement in RFID operation in a way that minimizes effects on wireless communication via the WWAN. For example, as presented herein, when the average Tag-Read-rate falls below a proposed internal metric (e.g., a minimum-tag-read-rate”), the UE may start to push RFID operation in the WWAN duty cycles within measurement gap occasions. The UE may further coordinate the measurement gap diversion with the network, e.g., by transmitting an UL MAC-CE (e.g., for “NR Meas-Gap Usage Diversion for Non-3GPP Request”) with a reserved LCID (e.g., such as LCID 47 for ULSCH). The base station may also transmit a DL MAC-CE (e.g., for “NR Meas-Gap Usage Diversion for Non-3GPP Response”) with a reserved LCID (e.g., LCID 46 for DLSCH). When the RFID Application is terminated, the UE subsequently transmits another instance of an UL MAC-CE (e.g. an “NR Meas-Gap Usage Diversion for Non-3GPP Request”) the reserved LCID (e.g., LCID 47 for ULSCH).

FIGS. 7-12 have described aspects of measurement gap usage diversion for RFID activity during the WWAN duty cycle.

In situations where a WWAN measurement gap occasion occurs within the RFID duty cycle, the WWAN component of the UE does not use the measurement gap occasions for neighbor cell measurements. Thus, in some aspects, a UE may miss opportunities for measurement that may affect WWAN performance. For example, a cell at cell edge or in poor serving cell conditions that skips the measurement gap occasions that occur within the RFID duty cycle may miss out on measuring and reporting candidate neighbor cells to a base station. The missed opportunity might hinder mobility (e.g., handing the UE over to a different serving cell), and may even lead to radio link failure in some cell conditions. Such reduced performance of the WWAN component of the UE may further impact RFID operation, e.g., as each subsequent WWAN cell recovery or re-acquisition may be given a higher priority within the TRM (e.g., and reduce the amount of time for RFID operation).

Aspects presented herein provide ways to allow the RFID stack to give access to a WWAN stack to initiate its activity within the measurement gap occasions that fall within the RFID duty cycle, e.g., to minimize the mobility impact due to neighbor cell measurements.

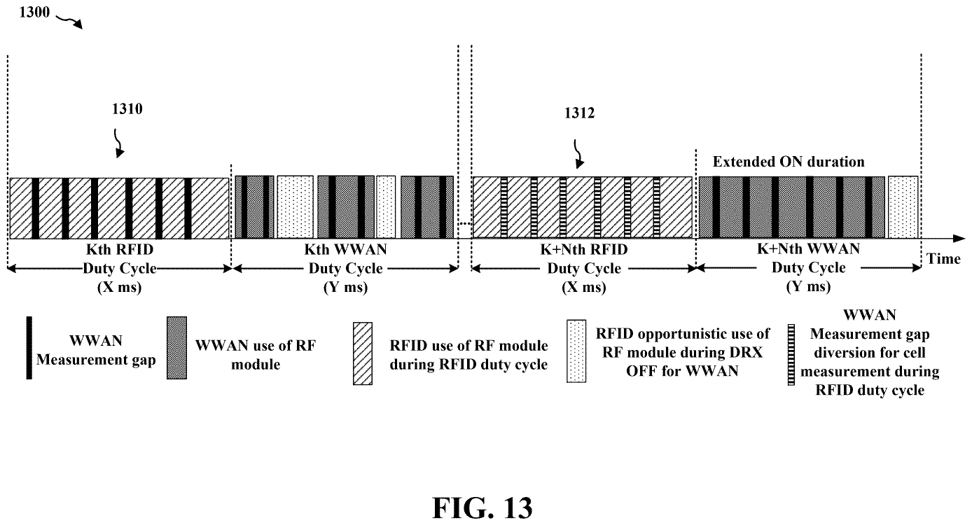

FIG. 13 illustrates an example timeline 1300 showing a TRM duty cycle that includes a repeating pattern of an REID duty cycle of X ms and a WWAN duty cycle of Y ms. The duty cycle may include any of the aspects described in connection with FIGS. 4A-6, for example. FIG. 13 illustrates that in addition to occurring during the WWAN duty cycle, WWAN measurement gaps occur during the RFID portion of the duty cycle. As the RF module is used by the RFID components during the RFID duty cycle, the WWAN component skips measurements during the WWAN measurement gaps that occur within the RFID duty cycle. FIG. 13 shows RFID+WWAN concurrency, in RRC connected mode (with one or more measurement gap configurations) with an REID Stack activated and a fixed TRM duty cycle sharing with WWAN.

The UE does not use measurement gaps occurring in the RFID duty cycles (e.g., in a time domain) for neighbor cell measurements. For example, even when the UE is at cell edge, e.g., and a serving cell RSRP falls below a certain threshold, there is no provision to improve the WWAN mobility performance based on a fixed TRM duty cycle sharing RF components between the RFID and the WWAN operation of the UE. If the skipped neighbor cell measurements result a radio link failure (RLF) and/or out of service (OOS) condition for the WWAN, e.g., due to bad cell conditions, then the RFID tag read rate may fall because subsequent WWAN cell recovery and re-acquisition is given a higher priority in the TRM.

Aspects presented herein allow the UE to use measurement gap occasions, even when if an occasion occurs within the RFID duty cycle, for neighbor measurements under certain conditions, such as in a prioritized gap measurement duration of time/time period (e.g., which may be referred to as a ‘Prioritized Gap Meas Window’). As an example, when a proposed “high mobility condition” occurs, and when the serving cell RSRP goes below a threshold (e.g., which may be defined, such as defined in a wireless standard), aspects presented herein may reduce impacts on UE mobility by enabling the UE to report candidate neighbor measurement and possibly honor upcoming handovers in a more efficient manner. For example, when the UE is experiencing bad channel conditions (e.g., such as when the serving cell SNR and RSRP drops below a threshold level), the UE may operate based on a cell edge condition to move to a better cell, e.g., by reporting candidate neighbor measurements and/or participating in a handover. The RFID stack may suspend ongoing operation on one or more measurement gap occasions within the RFID duty cycle, and the TRM can then allocate the measurement gap occasions (e.g., within the RFID duty cycle) for neighbor cell searches and/or measurement activity by the WWAN component of the UE.

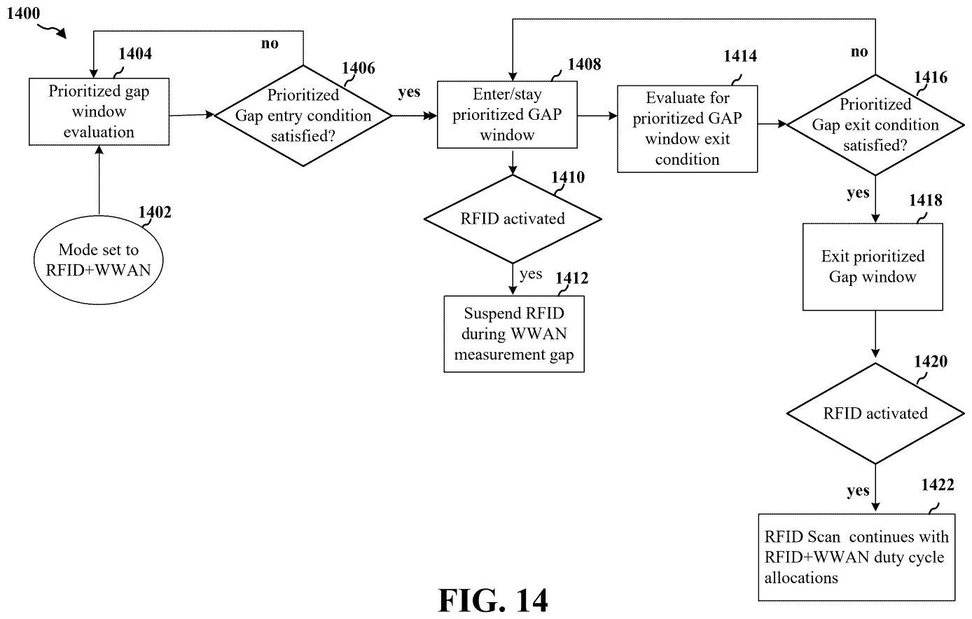

FIG. 14 illustrate an example flowchart 1400 showing aspects as presented herein for the reuse, or diversion, of measurement gaps that occur during an RFID duty cycle for WWAN neighbor cell measurement.

FIG. 14 illustrate an example flowchart 1400 showing aspects as presented herein for the reuse, or diversion, of measurement gaps that occur during an RFID duty cycle for WWAN neighbor cell measurement.

When an RFID application is initiated at the AP of a UE (e.g., UE 401 in FIG. 4A) and RFID stack (or RFID component) and WWAN stack (or WWAN component) (e.g., in an RRC connected mode) may start operating concurrently with a fixed TRM duty cycle sharing, e.g., as described in connection with any of FIGS. 4A-13. FIG. 14 shows the UE mode being set to RFID and WWAN operation, at 1402, for example. The lower layers (e.g., L1) of the WWAN stack may monitor one or more metrics of a WWAN serving cell (e.g., such as the RSRP of the serving cell) in the WWAN duty cycle period.

As shown at 1404, the UE may perform an evaluation regarding a prioritized gap measurement window (e.g., a window of time when WWAN measurements are prioritized in WWAN measurement gaps that occur within an RFID duty cycle). As shown at 1406, if the prioritized gap window condition is satisfied, the UE enters, or remains in a prioritized gap window, at 1408. If the condition(s) is not met, the UE may return to further evaluate the conditions, at 1404.

For a mobility based prioritized gap based window (e.g., a window of time during which the UE is to prioritize WWAN measurements during WWAN measurement gaps, including measurement gaps that occur within the RFID duty cycle). The UE may enter the “prioritized gap measurement window,” e.g., when one or more entry conditions are met. For example, when EntryCondition1 and EntryCondition2 both are met, the UE may enter the “prioritized gap measurement window.” As an example of a first entry condition (e.g., EntryCondition 1), the UE determines if, for a defined timing window (e.g., which may be referred to as “T_win”), the magnitude of fluctuation in a serving cell RSRP is greater than a threshold (e.g., which may be referred to as “max_rsrp_delta”). For example, if the magnitude of fluctuation in the serving cell RSRP is greater than the threshold, the condition may indicate that the UE is in a high-mobility state. As an example of a second entry condition (e.g., EntryConditon2), the UE may determine if an instantaneous serving cell RSRP is less than a threshold (e.g., which may be referred to as “Threshold_serv_low”) such as instantaneous serving cell RSRP<“Threshold_serv_low.” The threshold (e.g., threshold_serv_low) may be defined as a measurement reporting configuration event A2 threshold set by the network (e.g., base station), or in case the event A2 is not configured, then the threshold (e.g., threshold_serv_low) may be an internal metric in the WWAN L1 stack. The UE may exit the “Prioritized GAP Meas Window” when one or more exit conditions are met. As an example of a first exit condition (e.g., ExitConditon1), the condition may be that, for a predefined timing window (e.g., “T win”), the magnitude of fluctuation in the serving cell RSRP is less than a certain threshold (e.g., “min_rsrp_delta”). The first exit condition may indicate, e.g., that the UE is in a low mobility state. As an example of a second exit condition (e.g., ExitConditon2:), the condition may be met when the time to a latest mobility based ‘Prioritized GAP Meas Window’ Entry>T_min, where T_min is a threshold in time, such as an internally defined threshold.

For a prioritized gap based window based on cell edge conditions, the UE may enter the ‘Prioritized GAP Meas Window’ when a first entry condition and a second entry condition are met. As an example, the first entry condition may be that the SNR for the serving cell is less than a threshold, e.g., SNR<“Threshold_SNR_low,” where Threshold_SNR_low is an internal metric in the WWAN L1 stack. As an example, the second entry condition, may be that an instantaneous serving cell RSRP<“Threshold_serv_low−Δ₁.” The threshold_serv_low may correspond to a measurement reporting configuration event A2 threshold set by the network, or if the even A2 threshold is not configured by the network, the threshold_serv_low may be an internal metric in the WWAN L1 stack. The value of Δ₁ may correspond to the RSRP bias added to WWAN measurement to reduce the interruption on RFID. In the cell edge example the UE may exit the ‘Prioritized GAP Meas Window’ when one or more exit conditions are met. As an example, a first exit condition may correspond to an SNR>Threshold_SNR_high, where Threshold_SNR_high is internally defined in NR L1 stack. As an example, a second exit condition may be that an instantaneous serving cell RSRP>“Threshold_serv_high, where Threshold_serv_high is internally defined, e.g., in the WWAN L1 stack. As an example, a third exit condition may be that the time to a latest edge cell based ‘Prioritized GAP Meas Window’ Entry>T_min, where T_min is a threshold to time internally defined.

In situations where both the above conditions are TRUE for either mobility or Edge Cell conditions, the UE may determine that it is in a “Prioritized GAP Meas Window.” In this window (e.g., during a period of time associated with the window or until one or more exit conditions are met), the WWAN measurement gap occasions that occur within the RFID duty cycle may be used by the WWAN component of the UE for neighbor cell searches and measurements, e.g., while the UE suspends RFID activity. As shown at 1410, if the RFID is activated, the UE suspends the RFID activity, at 1412, during the WWAN measurement gaps that occur within the RFID duty cycle.

FIG. 14 shows that the UE may continue to evaluate conditions, at 1414, to determine whether a prioritized gap window exit condition is met. If the condition is determined, at 1416, to be satisfied, the UE exits the prioritized gap window at 1418. Otherwise, the UE may continue to stay in the prioritized gap window at 1408. Once the UE exits the prioritized gap window, at 1418, if the RFID s activated, as shown at 1420, the UE performs RFID scans based on the RFID and WWAN duty cycle allocations, at 1422, e.g., as described in connection with any of FIGS. 4A-13.

In the example in FIG. 13, the WWAN measurement gaps that occur during the Kth RFID duty cycle, shown at 1310, are not used for WWAN measurements, and the RF module is used instead by the RFID components of the UE (e.g., UE 401). In the K+Nth RFID duty cycle, as shown at 1312, the UE has determined that one or more conditions have occurred that indicate for the UE to prioritize WWAN measurement in the WWAN measurement gaps over RFID operation. The occurrence of the conditions may be considered as triggering a prioritized gap window, during which the UE suspends RFID activity during the WWAN measurement gaps that occur in the RFID duty cycle in order to perform neighbor cell measurements for the WWAN. The conditions may include any combination of the conditions described in connection with FIG. 14, for example. In some aspects, one or more conditions may be associated with a cell edge condition (or mode) of the UE. In some aspects, one or more conditions may be associated with a mobility condition (or mode) of the UE.

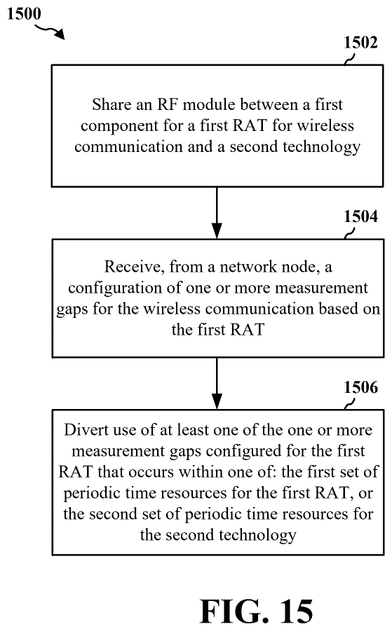

FIG. 15 is a flowchart 1500 of a method of wireless communication. The method may be performed by a UE (e.g., the UE 104, 350, 401, 798; the RFID component 1290; the WWAN component 1292; the apparatus 1704). At 1502, the UE shares a radio frequency (RF) module between a first component for a first radio access technology (RAT) for wireless communication and a second component for a second technology that is different than the first RAT, wherein the RF module is shared based on a duty cycle having a first set of periodic time resources for the first RAT and a second set of periodic time resources for the second technology. FIGS. 4A-14 illustrate various example aspects in connection with sharing an RF module between different technologies, including a first RAT for wireless communication and a second technology. In some aspects, the first RAT may include 5G new radio (NR) or 6G, and the second technology may include RFID. In some aspects, the first RAT ma includes a 3GPP RAT, and the second technology may include a non-3GPP technology. In some aspects, the first RAT for wireless communication may be referred to as a WWAN. The reception may be performed, e.g., by any of the measurement gap diversion component 198, the transceiver(s) 1722, and/or antenna(s) 1780 of the apparatus 1704.

At 1504, the UE receives, from a network node, a configuration of one or more measurement gaps for the wireless communication based on the first RAT. The configuration may identification the measurement gap configurations by a measurement gap configuration identifier, for example. The reception may be performed, e.g., by any of the measurement gap diversion component 198, the transceiver(s) 1722, and/or antenna(s) 1780 of the apparatus 1704.

At 1506, the UE diverts use of at least one of the one or more measurement gaps configured for the first RAT that occurs within one of: the first set of periodic time resources for the first RAT, or the second set of periodic time resources for the second technology. FIGS. 7-14 illustrate example aspects relating to reuse, or diversion, of one or more measurement gap occasions. The diverted use (e.g., which may be referred to as diversion) may be performed, e.g., by any of the measurement gap diversion component 198, the transceiver(s) 1722, and/or antenna(s) 1780 of the apparatus 1704.

In some aspects, the diversion of use may include using, for the second technology, the at least one measurement gap for the first RAT that occurs within the first set of periodic time resources for the first RAT based on the occurrence of at least one condition. The at least one condition may include a rate associated with the second technology falling below a threshold. In some aspects, the second technology may include RFID, and the at least one condition may include an average tag read rate that falls below a minimum tag read rate.

In some aspects, the second component for the second technology may send, to the first component for the first RAT, a request to use one or more measurement gaps. FIG. 7 illustrates an example of a request, e.g., at 736, and FIG. 12 illustrates an example request at 1202. In some aspects, the request indicates one or more of: a requested amount of measurement gap occasions to be used by the second technology within the first periodic resources for the first RAT, a requested percentage of measurement gap occasions to be used by the second technology within the first periodic resources for the first RAT, an identifier for one or more measurement configurations, a list of one or more currently inactive measurement configurations to be activated for use by the second technology, or a duration for measurement gap diversion for use by the second technology. In some aspects, the requested percentage of the measurement gap occasions, the duration for the measurement gap diversion, and the list of the one or more currently inactive measurement configurations to be activated are based on a difference between a minimum tag read rate and an average tag read rate measured by the UE. In some aspects, the second component for the second technology receives an internal response from the first component for the first RAT, wherein the response accepts, modifies, or rejects the request to use the at least one of the one or more measurement gaps. In some aspects, the internal response to the request to use the at least one of the one or more measurement gaps may be autonomously determined by the first component for the first RAT. As an example, FIG. 7 illustrates example aspects of option A of a UE determining to use measurement gap usage diversion without coordination with a base station. For example, option A, as shown at 714, may correspond to an autonomous measurement gap diversion, as shown at 712.

In some aspects, the UE may transmit an uplink medium access control-control element (MAC-CE) to a network node with an indication for measurement gap use for the second technology and receive a downlink MAC-CE that accepts, modifies, or rejects the measurement gap use for the second technology. FIG. 7 and FIG. 12 illustrate examples aspects in connection with transmission of an UL MAC-CE to indicate, or request, measurement gap usage diversion, and reception of a DL MAC-CE to accept, modify, or reject the request. In some aspects, the downlink MAC-CE includes one or more of: an identifier for one or more measurement configurations, an allowed number of measurement gap occasions to be used by the second technology within the first periodic resources for the first RAT, an allowed periodicity of the measurement gap occasions to be used by the second technology within the first periodic resources for the first RAT, or an allowed duration for the measurement gap usage diversion for the second technology.

In some aspects, the UE may stop use, for the second technology, of the at least one measurement gap for the first RAT that occurs within the first set of periodic time resources for the first RAT based on an average tag read rate that is greater than a minimum tag read rate multiplied by a factor. In some aspects, the UE may transmit an uplink medium access control-control element (MAC-CE) to a network node, wherein the uplink MAC-CE indicates that the UE will stop the use of the at least one measurement gap.

In some aspects, diverting use of the one or more measurement gaps includes using, for the first RAT, the at least one measurement gap for the first RAT that occurs within the second set of periodic time resources for the second technology. FIG. 13 and FIG. 14 illustrate examples aspects of measurement gap usage diversion for WWAN measurements during an RED duty cycle. In some aspects, a diversion of use of the one or more measurement gaps for the first RAT may be based on a mobility criteria, such as being based on: a magnitude of a fluctuation in a reference signal received power (RSRP) for a serving cell is greater than a first threshold, and an instantaneous RSRP for the serving cell is less than a second threshold. In some aspects, the UE may stop the use of the one or more measurement gaps for the first RAT based on one or more of: the magnitude of the fluctuation in the RSRP for the serving cell is greater than a third threshold, or a time to a latest mobility based prioritization of the one or more measurement gaps for the first RAT is greater than a fourth threshold.

In some aspects, the diversion usage of the measurement gaps may be based on a cell edge criteria. As an example, diverting the use of the one or more measurement gaps for the first RAT may be based on: a signal to noise ratio (SNR) is less than a first threshold, and an instantaneous reference signal received power (RSRP) for a serving cell is less than a second threshold. In some aspects, the UE may stop the use of the one or more measurement gaps for the first RAT based on one or more of: the SNR is greater than a third threshold, the instantaneous RSRP for the serving cell is greater than a fourth threshold, or a time to a latest cell edge based prioritization of the one or more measurement gaps for the first RAT is greater than a fifth threshold.

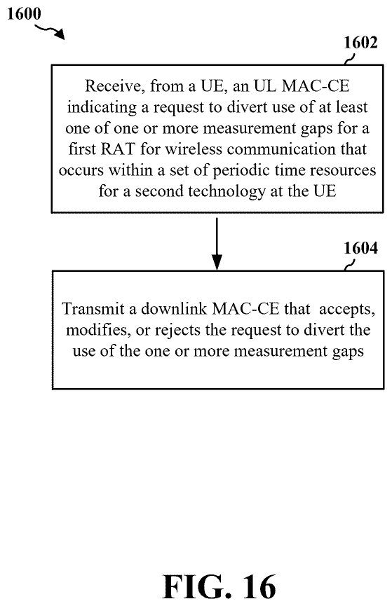

FIG. 16 is a flowchart 1600 of a method of wireless communication. At 1502, the UE be performed by a network node, which may be a base station in aggregation or one or more components of a disaggregated base station (e.g., the base station 102, 310, 796, 1296; a CU, a DU, an RU; the network entity 1802).

At 1602, the network node receives, from a user equipment (UE), an uplink medium access control-control element (MAC-CE) indicating a request to divert use of at least one of one or more measurement gaps for a first radio access technology (RAT) for wireless communication that occurs within a set of periodic time resources for a second technology at the UE. In some aspects, the uplink MAC-CE indicates one or more of: a requested amount of measurement gap occasions to be used by the second technology within the first periodic resources for the first RAT, a requested percentage of measurement gap occasions to be used by the second technology within the first periodic resources for the first RAT, an identifier for one or more measurement configurations, a list of one or more currently inactive measurement configurations to be activated for use by the second technology, or a duration for measurement gap diversion for use by the second technology. The reception may be performed, e.g., by the measurement gap diversion component 199 of the network entity 1802. FIG. 8 and FIG. 9 illustrate example aspects of an UL MAC-CE. FIG. 7 and FIG. 12 illustrate examples aspects of a base station receiving an UL MAC-CE from a UE to indicate measurement gap usage diversion.

At 1604, the network node transmits a downlink MAC-CE that accepts, modifies, or rejects the request to divert the use of the one or more measurement gaps. In some aspects, the downlink MAC-CE indicates one or more of: an identifier for one or more measurement configurations, an allowed number of measurement gap occasions to be used by the second technology within the first periodic resources for the first RAT, an allowed periodicity of the measurement gap occasions to be used by the second technology within the first periodic resources for the first RAT, or an allowed duration for the measurement gap usage diversion for the second technology. The transmission may be performed, e.g., by the measurement gap diversion component 199 of the network entity 1802. FIG. 9 and FIG. 11 illustrate example aspects of a DL MAC-CE. FIG. 7 and FIG. 12 illustrate examples aspects of a base station transmitting a DL MAC-CE to a UE relating to measurement gap usage diversion.

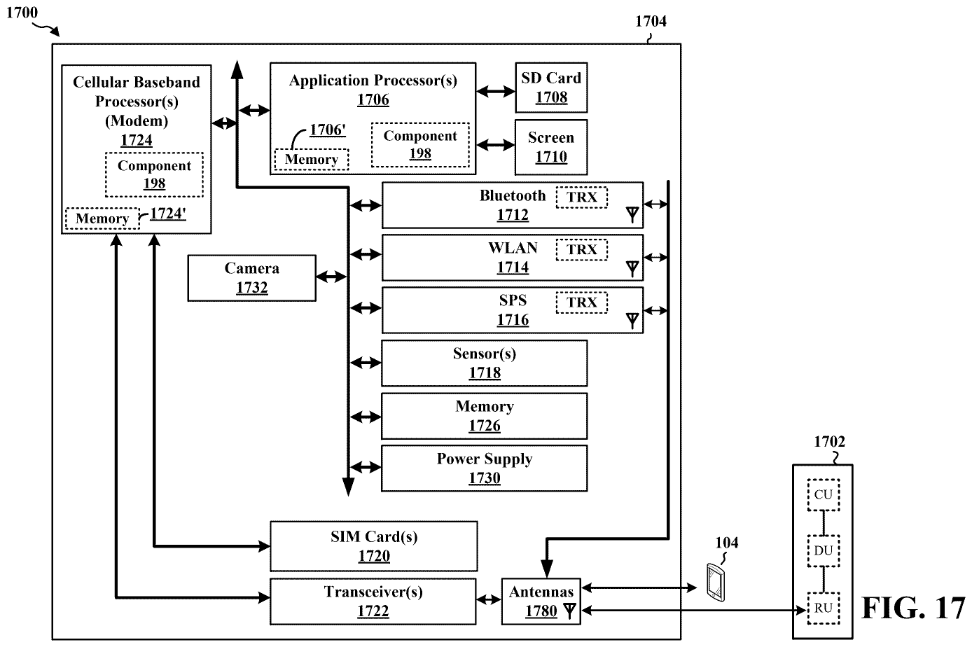

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include at least one cellular baseband processor 1724 (also referred to as a modem) coupled to one or more transceivers 1722 (e.g., cellular RF transceiver). The cellular baseband processor(s) 1724 may include at least one on-chip memory 1724′. In some aspects, the apparatus 1704 may further include one or more subscriber identity modules (SIM) cards 1720 and at least one application processor 1706 coupled to a secure digital (SD) card 1708 and a screen 1710. The application processor(s) 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor(s) 1724 communicates through the transceiver(s) 1722 via one or more antennas 1780 with the UE 104 and/or with an RU associated with a network entity 1702. The cellular baseband processor(s) 1724 and the application processor(s) 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor(s) 1724 and the application processor(s) 1706 are each responsible for general processing, including the execution of software stored on the computer-readable medium/memory. The software, when executed by the cellular baseband processor(s) 1724/application processor(s) 1706, causes the cellular baseband processor(s) 1724/application processor(s) 1706 to perform the various functions described supra. The cellular baseband processor(s) 1724 and the application processor(s) 1706 are configured to perform the various functions described supra based at least in part of the information stored in the memory. That is, the cellular baseband processor(s) 1724 and the application processor(s) 1706 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1724/application processor(s) 1706 when executing software. The cellular baseband processor(s) 1724/application processor(s) 1706 may be a component of the UE 350 and may include the at least one memory 360 and/or at least one of the TX processor 368, the RX processor 356, and the controller/processor 359. In one configuration, the apparatus 1704 may be at least one processor chip (modem and/or application) and include just the cellular baseband processor(s) 1724 and/or the application processor(s) 1706, and in another configuration, the apparatus 1704 may be the entire UE (e.g., see UE 350 of FIG. 3) and include the additional modules of the apparatus 1704.

As discussed supra, the component 198 may be configured to share a radio frequency (RF) module between a first component for a first radio access technology (RAT) for wireless communication and a second component for a second technology that is different than the first RAT, wherein the RF module is shared based on a duty cycle having a first set of periodic time resources for the first RAT and a second set of periodic time resources for the second technology; receive, from a network node, a configuration of one or more measurement gaps for the wireless communication based on the first RAT; and divert use of at least one of the one or more measurement gaps configured for the first RAT that occurs within one of: the first set of periodic time resources for the first RAT, or the second set of periodic time resources for the second technology. The apparatus or the component 198 may be further configured to perform any of the aspects described in connection with the flowchart in FIG. 15 and/or performed by the UE in any of FIGS. 4A-14. The component 198 may be within the cellular baseband processor(s) 1724, the application processor(s) 1706, or both the cellular baseband processor(s) 1724 and the application processor(s) 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1704 may include a variety of components configured for various functions. In one configuration, the apparatus 1704, and in particular the cellular baseband processor(s) 1724 and/or the application processor(s) 1706, may include means for sharing a radio frequency (RF) module between a first component for a first radio access technology (RAT) for wireless communication and a second component for a second technology that is different than the first RAT, wherein the RF module is shared based on a duty cycle having a first set of periodic time resources for the first RAT and a second set of periodic time resources for the second technology; means for receiving, from a network node, a configuration of one or more measurement gaps for the wireless communication based on the first RAT; and means for diverting use of at least one of the one or more measurement gaps configured for the first RAT that occurs within one of: the first set of periodic time resources for the first RAT, or the second set of periodic time resources for the second technology. The apparatus may further include means for performing any of the aspects described in connection with the flowchart in FIG. 15 and/or performed by the UE in any of FIGS. 4A-14. The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

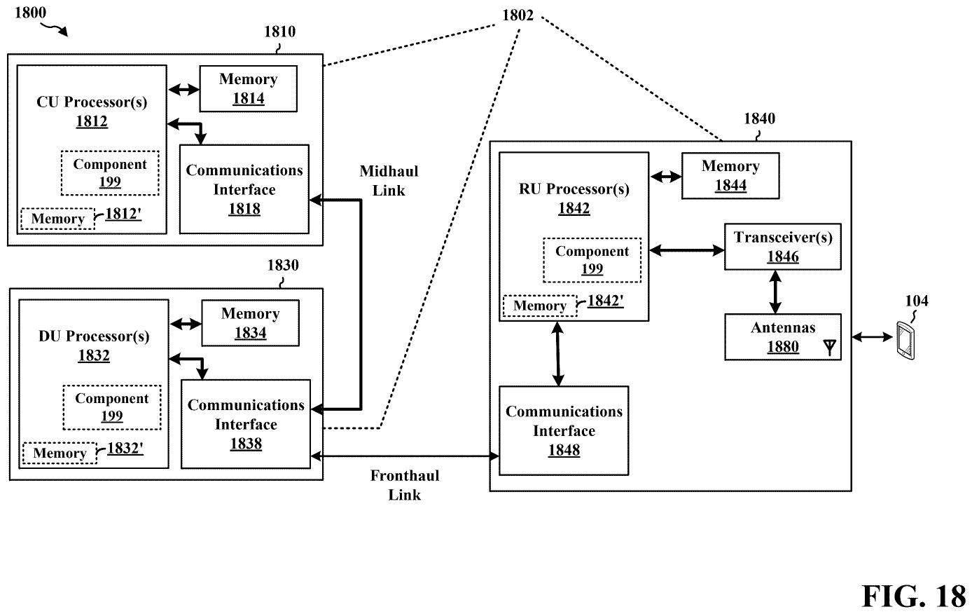

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include at least one CU processor 1812. The CU processor(s) 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include at least one DU processor 1832. The DU processor(s) 1832 may include on-chip memory 1832′. In some aspects, the DU 1830 may further include additional memory modules 1834 and a communications interface 1838. The DU 1830 communicates with the RU 1840 through a fronthaul link. The RU 1840 may include at least one RU processor 1842. The RU processor(s) 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a user equipment (UE), an uplink medium access control-control element (MAC-CE) indicating a request to divert use of at least one of one or more measurement gaps for a first radio access technology (RAT) for wireless communication that occurs within a set of periodic time resources for a second technology at the UE; and transmit a downlink MAC-CE that accepts, modifies, or rejects the request to divert the use of the one or more measurement gaps. The network entity and/or the component 199 may be further configured to perform any of the aspects described in connection with the flowchart in FIG. 16 and/or performed by the base station, or network node, in FIG. 7. The component 199 may be within one or more processors of one or more of the CU 1810, DU 1830, and the RU 1840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1802 may include a variety of components configured for various functions. In one configuration, the network entity 1802 may include means for receiving, from a user equipment (UE), an uplink medium access control-control element (MAC-CE) indicating a request to divert use of at least one of one or more measurement gaps for a first radio access technology (RAT) for wireless communication that occurs within a set of periodic time resources for a second technology at the UE; and means for transmitting a downlink MAC-CE that accepts, modifies, or rejects the request to divert the use of the one or more measurement gaps. The network entity may further include means for performing any of the aspects described in connection with the flowchart in FIG. 16 and/or performed by the base station, or network node, in FIG. 7. The means may be the component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S F F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: sharing a radio frequency (RF) module between a first component for a first radio access technology (RAT) for wireless communication and a second component for a second technology that is different than the first RAT, wherein the RF module is shared based on a duty cycle having a first set of periodic time resources for the first RAT and a second set of periodic time resources for the second technology; receiving, from a network node, a configuration of one or more measurement gaps for the wireless communication based on the first RAT; and diverting use of at least one of the one or more measurement gaps configured for the first RAT that occurs within one of: the first set of periodic time resources for the first RAT, or the second set of periodic time resources for the second technology.

In aspect 2, the method of aspect 1 further includes that diverting the use of the at least one of the one or more measurement gaps includes: using, for the second technology, the at least one of the one or more measurement gaps for the first RAT that occurs within the first set of periodic time resources for the first RAT based on an occurrence of at least one condition.

In aspect 3, the method of aspect 1 or 2 further includes that the at least one condition includes a rate associated with the second technology falling below a threshold.

In aspect 4, the method of any of aspects 1-3 further includes that the second technology includes radio frequency identification (RFID), and the at least one condition includes an average tag read rate that falls below a minimum tag read rate.

In aspect 5, the method of any of aspects 1-4 further includes that the second component for the second technology sends to the first component for the first RAT a request to use the at least one of the one or more measurement gaps.

In aspect 6, the method of aspect 5 further includes that the request indicates one or more of: a requested amount of measurement gap occasions to be used by the second technology within the first set of periodic time resources for the first RAT, a requested percentage of the measurement gap occasions to be used by the second technology within the first set of periodic time resources for the first RAT, an identifier for one or more measurement configurations, a list of one or more currently inactive measurement configurations to be activated for use by the second technology, or a duration for measurement gap diversion for use by the second technology.

In aspect 7, the method of aspect 6 further includes that the requested percentage of the measurement gap occasions, the duration for the measurement gap diversion, and the list of the one or more currently inactive measurement configurations to be activated are based on a difference between a minimum tag read rate and an average tag read rate measured by the UE.

In aspect 8, the method of any of aspects 5-7 further includes that receiving a response from the first component for the first RAT, wherein the response indicates an acceptance, a modification, or a rejection of the request to use the at least one of the one or more measurement gaps.

In aspect 9, the method of aspect 8 further includes that the response to the request for use of the at least one of the one or more measurement gaps is autonomously determined by the first component for the first RAT.

In aspect 10, the method of any of aspects 9 further includes that transmitting an uplink medium access control-control element (MAC-CE) to the network node with an indication for measurement gap use for the second technology; and receiving a downlink MAC-CE that accepts, modifies, or rejects the measurement gap use for the second technology, wherein the downlink MAC-CE includes one or more of: an identifier for at least one measurement gap configuration, an allowed number of measurement gap occasions to be used by the second technology within the first set of periodic time resources for the first RAT, an allowed periodicity of at least one measurement gap occasion to be used by the second technology within the first set of periodic time resources for the first RAT, or an allowed duration for a measurement gap usage diversion for the second technology.

In aspect 11, the method of any of aspects 2-10 further includes stopping the use, for the second technology, of the at least one of the one or more measurement gaps for the first RAT that occurs within the first set of periodic time resources for the first RAT based on an average tag read rate that is greater than a minimum tag read rate multiplied by a factor.

In aspect 12, the method of any of aspects 2-11 further includes transmitting an uplink medium access control-control element (MAC-CE) to the network node, wherein the uplink MAC-CE indicates that the UE will stop the use of the at least one of the one or more measurement gaps.

In aspect 13, the method of aspect 1 further includes that diverting use of the at least one of the one or more measurement gaps includes: using, for the first RAT, the at least one of the one or more measurement gaps for the first RAT that occurs within the second set of periodic time resources for the second technology.

In aspect 14, the method of aspect 13 further includes that the use of the one or more measurement gaps for the first RAT is based on: a magnitude of a fluctuation in a reference signal received power (RSRP) for a serving cell is greater than a first threshold, and an instantaneous RSRP for the serving cell is less than a second threshold.

In aspect 15, the method of aspect 14 further includes stopping the use of the one or more measurement gaps for the first RAT based on one or more of: the magnitude of the fluctuation in the RSRP for the serving cell is greater than a third threshold, or a time to a latest mobility based prioritization of the one or more measurement gaps for the first RAT is greater than a fourth threshold.

In aspect 16, the method of any of aspects 13-15 further includes that a use of the one or more measurement gaps for the first RAT is based on: a signal to noise ratio (SNR) is less than a first threshold, and an instantaneous reference signal received power (RSRP) for a serving cell is less than a second threshold.

In aspect 17, the method of aspect 16 further includes stopping the use of the one or more measurement gaps for the first RAT based on one or more of: the SNR is greater than a third threshold, the instantaneous RSRP for the serving cell is greater than a fourth threshold, or a time to a latest cell edge based prioritization of the one or more measurement gaps for the first RAT is greater than a fifth threshold.

In aspect 18, the method of any of aspects 1-17 further includes that the first RAT includes 5G new radio (NR) or 6G, and wherein the second technology includes radio frequency identification (RFID).

In aspect 19, the method of any of aspects 1-17 further includes that the first RAT includes a Third Generation Partnership Project (3GPP) RAT, and wherein the second technology includes a non-3GPP technology.

Aspect 20 is a method of wireless communication at a network node, comprising: receiving, from a user equipment (UE), an uplink medium access control-control element (MAC-CE) indicating a request to divert use of one or more measurement gaps for a first radio access technology (RAT) for wireless communication that occurs within first set of periodic time resources for a second technology at the UE; and transmitting a downlink MAC-CE that accepts, modifies, or rejects the request to divert the use of the one or more measurement gaps.

In aspect 21, the method of aspect 20 further incudes that the uplink MAC-CE indicates one or more of: a requested amount of measurement gap occasions to be used by the second technology within the first set of periodic time resources for the first RAT, a requested percentage of the measurement gap occasions to be used by the second technology within the first set of periodic time resources for the first RAT, an identifier for one or more measurement configurations, a list of one or more currently inactive measurement configurations to be activated for use by the second technology, or a duration for measurement gap diversion for use by the second technology.

In aspect 22, the method of aspect 20 or 21 further includes that the downlink MAC-CE indicates one or more of: the identifier for the one or more measurement configurations, an allowed number of measurement gap occasions to be used by the second technology within the first set of periodic time resources for the first RAT, an allowed periodicity of the measurement gap occasions to be used by the second technology within the first set of periodic time resources for the first RAT, or an allowed duration for the measurement gap usage diversion for the second technology.

In aspect 23, the method of any of aspects 20-22 further includes that the first RAT includes 5G new radio (NR) or 6G, and wherein the second technology includes radio frequency identification (RFID).

In aspect 24, the method of any of aspects 20-22 further includes that the first RAT includes a Third Generation Partnership Project (3GPP) RAT, and wherein the second technology includes a non-3GPP technology.

Aspect 25 is an apparatus for wireless communication at a UE, comprising: at least one memory; and at least one processor coupled to the at least one memory, the at least one processor is configured to perform the method of any of aspects 1 to 19.

Aspect 26 is an apparatus for wireless communication at a UE, comprising means for performing each step in the method of any of aspects 1 to 19.

Aspect 27 is the apparatus of any of aspects 25-26, further comprising a transceiver configured to receive or to transmit in association with the method of any of aspects 1 to 19.

Aspect 28 is a computer-readable medium storing computer executable code at a UE, the code when executed by at least one processor causes the at least one processor to perform the method of any of aspects 1 to 19.

Aspect 29 is an apparatus for wireless communication at a network node, comprising: at least one memory; and at least one processor coupled to the at least one memory, the at least one processor is configured to perform the method of any of aspects 20 to 24.

Aspect 30 is an apparatus for wireless communication at a network node, comprising means for performing each step in the method of any of aspects 20 to 24.

Aspect 31 is the apparatus of any of aspects 29 to 30, further comprising a transceiver configured to receive or to transmit in association with the method of any of aspects 20 to 24.

Aspect 32 is a computer-readable medium storing computer executable code at a network node, the code when executed by at least one processor causes the at least one processor to perform the method of any of aspects 20 to 24.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
share a radio frequency (RF) module between a first component for a first radio access technology (RAT) for wireless communication and a second component for a second technology that is different than the first RAT, wherein the RF module is shared based on a duty cycle having a first set of periodic time resources for the first RAT and a second set of periodic time resources for the second technology;
receive, from a network node, a configuration of one or more measurement gaps for the wireless communication based on the first RAT; and
divert use of at least one of the one or more measurement gaps configured for the first RAT that occurs within one of:
the first set of periodic time resources for the first RAT, or
the second set of periodic time resources for the second technology.

2. The apparatus of claim 1, wherein diversion of the use of the at least one of the one or more measurement gaps includes:
use, for the second technology, of the at least one of the one or more measurement gaps for the first RAT that occurs within the first set of periodic time resources for the first RAT based on an occurrence of at least one condition.

3. The apparatus of claim 2, wherein the at least one condition includes a rate associated with the second technology falling below a threshold.

4. The apparatus of claim 3, wherein the second technology includes radio frequency identification (RFID), and the at least one condition includes an average tag read rate that falls below a minimum tag read rate.

5. The apparatus of claim 2, wherein the second component for the second technology sends to the first component for the first RAT a request to use the at least one of the one or more measurement gaps.

6. The apparatus of claim 5, wherein the request indicates one or more of:
a requested amount of measurement gap occasions to be used by the second technology within the first set of periodic time resources for the first RAT,
a requested percentage of the measurement gap occasions to be used by the second technology within the first set of periodic time resources for the first RAT,
an identifier for one or more measurement configurations,
a list of one or more currently inactive measurement configurations to be activated for use by the second technology, or
a duration for measurement gap diversion for use by the second technology.

7. The apparatus of claim 6, wherein the requested percentage of the measurement gap occasions, the duration for the measurement gap diversion, and the list of one or more currently inactive measurement configurations to be activated are based on a difference between a minimum tag read rate and an average tag read rate measured by the UE.

8. The apparatus of claim 5, wherein the at least one processor is further configured to:
receive a response from the first component for the first RAT, wherein the response indicates an acceptance, a modification, or a rejection of the request to use the at least one of the one or more measurement gaps.

9. The apparatus of claim 8, wherein the response to the request for use of the at least one of the one or more measurement gaps is autonomously determined by the first component for the first RAT.

10. The apparatus of claim 8, wherein the at least one processor is further configured to:
transmit an uplink medium access control-control element (MAC-CE) to the network node with an indication for measurement gap use for the second technology; and
receive a downlink MAC-CE that accepts, modifies, or rejects the measurement gap use for the second technology, wherein the downlink MAC-CE includes one or more of:
an identifier for at least one measurement gap configuration,
an allowed number of measurement gap occasions to be used by the second technology within the first set of periodic time resources for the first RAT,
an allowed periodicity of at least one measurement gap occasion to be used by the second technology within the first set of periodic time resources for the first RAT, or
an allowed duration for a measurement gap usage diversion for the second technology.

11. The apparatus of claim 2, wherein the at least one processor is further configured to:
stop the use, for the second technology, of the at least one of the one or more measurement gaps for the first RAT that occurs within the first set of periodic time resources for the first RAT based on an average tag read rate that is greater than a minimum tag read rate multiplied by a factor.

12. The apparatus of claim 11, wherein the at least one processor is further configured to:
transmit an uplink medium access control-control element (MAC-CE) to the network node, wherein the uplink MAC-CE indicates that the UE will stop the use of the at least one of the one or more measurement gaps.

13. The apparatus of claim 1, wherein diversion of use of the at least one of the one or more measurement gaps includes:
use, for the first RAT, of the at least one of the one or more measurement gaps for the first RAT that occur within the second set of periodic time resources for the second technology.

14. The apparatus of claim 13, wherein the use of the one or more measurement gaps for the first RAT is based on:
a magnitude of a fluctuation in a reference signal received power (RSRP) for a serving cell is greater than a first threshold, and
an instantaneous RSRP for the serving cell is less than a second threshold.

15. The apparatus of claim 14, wherein the at least one processor is further configured to:
stop the use of the one or more measurement gaps for the first RAT based on one or more of:
the magnitude of the fluctuation in the RSRP for the serving cell is greater than a third threshold, or
a time to a latest mobility based prioritization of the one or more measurement gaps for the first RAT is greater than a fourth threshold.

16. The apparatus of claim 13, wherein a use of the one or more measurement gaps for the first RAT is based on:
a signal to noise ratio (SNR) is less than a first threshold, and
an instantaneous reference signal received power (RSRP) for a serving cell is less than a second threshold.

17. The apparatus of claim 16, wherein the at least one processor is further configured to:
stop the use of the one or more measurement gaps for the first RAT based on one or more of:
the SNR is greater than a third threshold,
the instantaneous RSRP for the serving cell is greater than a fourth threshold, or
a time to a latest cell edge based prioritization of the one or more measurement gaps for the first RAT is greater than a fifth threshold.

18. The apparatus of claim 1, wherein the first RAT includes 5G new radio (NR) or 6G, and wherein the second technology includes radio frequency identification (RFID), or
wherein the first RAT includes a Third Generation Partnership Project (3GPP) RAT, and wherein the second technology includes a non-3GPP technology.

19. An apparatus for wireless communication at a network node, comprising:
at least one memory; and
at least one processor coupled to the at least one memory and, based at least in part on information stored in the at least one memory, the at least one processor is configured to:
receive, from a user equipment (UE), an uplink medium access control-control element (MAC-CE) indicating a request to divert use of one or more measurement gaps for a first radio access technology (RAT) for wireless communication that occurs within first set of periodic time resources for a second technology at the UE; and
transmit a downlink MAC-CE that accepts, modifies, or rejects the request to divert the use of the one or more measurement gaps.

20. The apparatus of claim 19, wherein the uplink MAC-CE indicates one or more of:
a requested amount of measurement gap occasions to be used by the second technology within the first set of periodic time resources for the first RAT,
a requested percentage of the measurement gap occasions to be used by the second technology within the first set of periodic time resources for the first RAT,
an identifier for one or more measurement configurations,
a list of one or more currently inactive measurement configurations to be activated for use by the second technology, or
a duration for measurement gap diversion for use by the second technology,
and wherein the downlink MAC-CE indicates one or more of:
the identifier for the one or more measurement configurations,
an allowed number of measurement gap occasions to be used by the second technology within the first set of periodic time resources for the first RAT,
an allowed periodicity of the measurement gap occasions to be used by the second technology within the first set of periodic time resources for the first RAT, or
an allowed duration for the measurement gap diversion for the second technology.
